(19) United States
(12) Patent Application Publication
(10) Pub. No.: US 2017/0160866 A1
(43) Pub. Date: Jun. 8, 2017

(54) TOUCH DISPLAY DEVICE

(71) Applicant: Innolux Corporation, Chu-Nan (TW)

(72) Inventor: Chia-Hao TSAI, Chu-Nan (TW)

(73) Assignee: Innolux Corporation, Chu-Nan (TW)

(21) Appl. No.: 15/371,833

(22) Filed: Dec. 7, 2016

Related U.S. Application Data
(60) Provisional application No. 62/264,356, filed on Dec. 8, 2015.

(30) Foreign Application Priority Data
Mar. 8, 2016 (TW) 105107073

(51) Int. Cl. G06F 3/041; G06F 3/044

(52) U.S. Cl. CPC G06F 3/0416; G06F 3/0412; G06F 3/044; G06F 2203/04105; G06F 2203/04106

(57) ABSTRACT

A touch display device includes a first substrate layer, a second substrate layer, a first electrode layer, a second electrode layer and a controller. The first substrate layer includes a plurality of transistors. The second substrate layer is disposed opposite to the first substrate layer. The first electrode layer is disposed over the first substrate layer and interposed between the first substrate layer and the second substrate layer. The second electrode layer is disposed over the second substrate layer and interposed between the first substrate layer and the second substrate layer. The controller is electrically connected to the first electrode layer.

This application claims the benefits of U.S. provisional application Ser. No. 62/264,356, filed on Dec. 8, 2015 and Taiwan application Serial No. 105107073, filed on Mar. 8, 2016, the subject matters of which are incorporated herein by reference.

### BACKGROUND

Field of the Invention

The disclosure relates in general to a touch display device, and more particularly to a touch display device with pressure sensing function.

Description of the Related Art

The touch display device has been widely used in various electronic products such as smartphones, tablets, and laptops. To improve user experience, a touch display device with pressure sensing function is further provided. Apart from sensing a finger or a stylus on a touch plane, the touch display device with pressure sensing function further activates corresponding operations in response to the magnitude of the pressing force. Since the touch display device normally has a pressure sensor stacked on the rear of the panel, the manufacturing difficulty and costs of relevant parts are increased. Moreover, thickness of the touch display device may be affected.

### SUMMARY

The disclosure is directed to a touch display device with pressure sensing function. With the electrodes formed on an inner side of the second substrate layer (such as a color filter substrate or a transparent substrate) and the electrodes formed on the first substrate layer (such as pixel thin-film transistor substrate) of the touch panel, the sensing output signal generated by a controller when the touch display device is pressed can be significantly increased. Thus, the controller can determine whether the touch event is a plane touch event or a pressing touch event according to the magnitude of the sensing output signal. Such architecture not only dispenses with the use of pressure sensor disposed to provide pressure sensing function, but further increases signal quality and improves overall touch and display function.

According to a one aspect of the disclosure, a touch display device is provided. The touch display device includes a first substrate layer, a second substrate layer, a first electrode layer, a second electrode layer and a controller. The first substrate layer includes a plurality of transistors. The second substrate layer is disposed opposite to the first substrate layer. The first electrode layer is disposed over the first substrate layer and interposed between the first substrate layer and the second substrate layer. The second electrode layer is disposed over the second substrate layer and interposed between the first substrate layer and the second substrate layer. The controller is electrically connected to the first electrode layer, wherein the controller outputs a first signal to the first electrode layer when the touch display device is operated under a display mode and outputs a second signal to the first electrode layer when the touch display device is operated under a touch mode; wherein when the touch display device is operated under the touch mode, the controller generates a sensing output signal and determines whether a touch event occurs according to whether the value of the sensing output signal is over a first threshold, the controller further determines whether the touch event is a plane touch event or a pressing touch event according to whether the value of the sensing output signal is over a second threshold.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 is a cross-sectional view of a touch display device according to an embodiment of the disclosure.

FIGS. 2-4 are top views of different implementations of a first electrode layer.

FIG. 5 is an example of a schematic diagram of relevant signal operations for transistors by a controller when the touch display device is operated under different modes.

FIGS. 6-8 are schematic diagrams of a second electrode layer implemented with different electrode patterns.

FIG. 9(a) is a cross-sectional view of a touch display device according to an embodiment of the disclosure.

FIG. 9(b) is a schematic diagram of a touch event on a touch display device.

FIG. 10 is an example of a wave-pattern of a sensing output signal.

FIG. 11 is another example of a wave-pattern of a sensing output signal.

FIG. 12 is a cross-sectional view of a touch display device according to an embodiment of the disclosure.

FIG. 13 is a cross-sectional view of a touch display device according to an embodiment of the disclosure.

FIG. 14 is a cross-sectional view of a touch display device according to an embodiment of the disclosure.

FIG. 15 is a cross-sectional view of a touch display device according to an embodiment of the disclosure.

FIG. 16(a) is a cross-sectional view of a touch display device according to an embodiment of the disclosure.

FIG. 16(b) is a cross-sectional view of a touch display device when a touch event occurs.

FIG. 16(c) is a relevant equivalent circuit diagram of a touch display device when no touch event occurs.

FIG. 16(d) is a relevant equivalent circuit diagram of a touch display device when a plane touch event occurs.

FIG. 16(e) is a relevant equivalent circuit diagram of a touch display device when a pressing touch event occurs.

FIG. 17 is an example of a wave-pattern of a sensing output signal.

FIG. 18 is another example of a wave-pattern of a sensing output signal.

FIG. 19 is an example of a top view of a first electrode layer and a second electrode layer.

FIG. 20 is an example of a cross-sectional view of a touch display device when a touch event occurs according to an embodiment of the disclosure.

FIG. 21 is an example of a cross-sectional view of a touch display device when a touch event occurs according to an embodiment of the disclosure.

FIGS. 22(a)-22(b) are relevant equivalent circuit diagrams of the touch display device of FIGS. 20 and 21 under different touch events.

FIG. 23 is an example of a wave-pattern of a sensing output signal.

FIG. 24 is an example of a schematic diagram of relevant signal operations for pixel transistors by a controller when the touch display device is operated under different modes.

FIG. 25(a) is a cross-sectional view of a touch display device according to an embodiment of the disclosure.

FIG. 25(b) is an example of a top view of a first electrode layer, a second electrode layer and a third electrode layer.

FIG. 26 is an example of a cross-sectional view of a touch display device when a touch event occurs according to an embodiment of the disclosure.

FIG. 27 is an example of a cross-sectional view of a touch display device when a touch event occurs according to an embodiment of the disclosure.

FIG. 28(a)-28(b) are relevant equivalent circuit diagrams of the touch display device of FIGS. 26 and 27 when a plane touch event occurs.

FIG. 29 is an example of a wave-pattern of a sensing output signal.

FIG. 30(a)-30(b) relevant equivalent circuit diagrams of the touch display device of FIGS. 26 and 27 when a pressing touch event occurs.

FIG. 31 is an example of a wave-pattern of a sensing output signal.

FIG. 32 is an example of a schematic diagram of relevant signal operations for transistors by a controller when the touch display device is operated under different modes.

FIG. 33 is an example of a top view of a first electrode layer, a second electrode layer and a third electrode layer.

### DETAILED DESCRIPTION OF EMBODIMENTS

In the specification, some embodiments of the disclosure are described with reference to accompanying drawings, but not all embodiments are illustrated with accompanying drawings. The disclosure can have different variations, and is not limited to the embodiments illustrated in the specification. The present disclosure provides the embodiments to meet legal requirements. Designations common to the accompanying drawings are used to indicate identical or similar elements.

It should be noted that the elements or devices in the drawings of the present disclosure may be present in any form or configuration known to those skilled in the art. In addition, the expression “a layer overlying another layer”, “a layer is disposed above another layer”, “a layer is disposed on another layer” and “a layer is disposed over another layer” may indicate not only that the layer directly contacts the other layer, but also that the layer does not directly contact the other layer. For example, one or more intermediate layers may dispose between the layer and the other layer.

It should be noted that the various embodiments disclosed below includes multiple technical features that are not limited to each specific embodiment. Rather, the multiple technical features in different embodiments can be mixed or combined to form another embodiment.

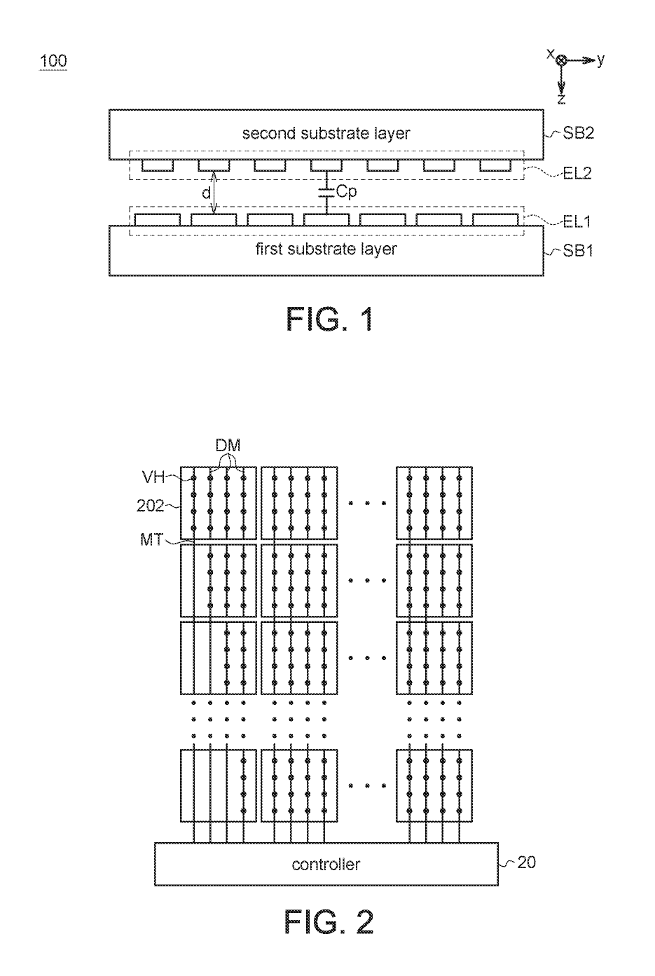

FIG. 1 is a cross-sectional view of a touch display device 100 according to an embodiment of the disclosure. The touch display device 100 includes a first substrate layer SB1, a second substrate layer SB2, a first electrode layer EL1 and a second electrode layer EL2. The touch display device 100 can be a LCD display, OLED display, LED display, or QD (quantum dot) display. However, the disclosure is not limited thereto.

The first substrate layer SB1 can be realized by a thin-film transistor (TFT) substrate, and includes a plurality of pixels and a plurality of transistors (not illustrated in the diagram). The second substrate layer SB2 and the first substrate layer SB1 are disposed oppositely. The second substrate layer SB2 can be realized by a color filter glass substrate or a transparent substrate, but is not limited thereto. The first substrate layer SB1 and the second substrate layer SB2 can comprise a rigid substrate, such as glass, ceramic, quartz, or sapphire, or a flexible substrate, such as polyimide, polycarbonate, polyethylene terephthalate. However, the disclosure is not limited thereto.

The first electrode layer EL1 is formed on the first substrate layer SB1 and interposed between the first substrate layer SB1 and the second substrate layer SB2. The voltage of the first electrode layer EL1 is controlled by a controller (not illustrated in the diagram) of the touch display device 100. Within a control cycle, the first electrode layer EL1 can be selectively used as a common electrode layer of the pixels or a touch electrode layer for detecting a touch event. For example, when the touch display device 100 is operated under the display mode, the controller outputs a first signal (such as a common voltage) to the first electrode layer EL1, such that the first electrode layer EL1 is used as a common electrode of the pixels. When the touch display device 100 is operated under the touch mode, the controller outputs a second signal (such as a touch sensing pulse) to the first electrode layer EL1, such that the first electrode layer EL1 is used as a touch electrode.

The second electrode layer EL2 is formed on the second substrate layer SB2 and interposed between the first substrate layer SB1 and the second substrate layer SB2 to form a capacitor Cp with the first electrode layer EL1. The second electrode layer EL2 can be formed of a transparent conductive material or a metal material. However, the disclosure is not limited thereto.

The first electrode layer EL1 and the second electrode layer EL2 can be separated by a display medium which can be used as a dielectric layer of the capacitor Cp. The magnitude of the capacitance of the capacitor Cp is correlated with the gap d between the first and the second electrode layers EL1 and EL2 and the size of the electrode pattern of the first and the second electrode layers EL1 and EL2. The display medium can comprise a liquid crystal layer, an organic light-emitting diode layer, or a light-emitting diode layer. However, the disclosure is not limited thereto.

According to an embodiment of the disclosure, the gap d between the first and the second electrode layers EL1 and EL2 varies with the received force. For example, when a finger presses the substrate and causes the gap d to decrease, the capacitance of the capacitor Cp will increase and the controller will sense a sensing output signal larger than that sensed in an ordinary plane touch event (such as sliding or light touch on a touch plane along the x direction or the y direction). The touch display device being pressed to trigger a sensing output signal. And the sensing output signal becomes large enough to be differentiated from the sensing output signal corresponding to the plane touch event, the controller will identify that the touch event is a pressing touch event (for example, the touch screen is pressed with a certain amount of force) along a vertical direction (such as the z direction), not a plane touch event. Therefore, for the controller of the touch display device 100, both the sensing output signals respectively triggered by the plane touch event and the pressing touch event belong to the same signal channel. The controller can determine whether a touch event occurs and whether the touch event is a plane touch event or a pressing touch event according to a comparison between the sensing output signal and a plurality of thresholds. For example, the controller can determine whether the touch event occurs according to whether the value of the sensing output signal is greater than a first threshold, and determine whether the touch event is a plane touch event or a pressing touch event according to whether the value of the sensing output signal is greater than a second threshold.

FIGS. 2-4 are top views of different implementations of a first electrode layer. In the example illustrated in FIG. 2, the first electrode layer EL1 is realized by a self-capacitive in-cell touch structure. As indicated in FIG. 2, the first electrode layer EL1 is patterned as a plurality of unit electrode blocks 202 electrically isolated from each other. Each unit electrode block 202 is connected to the controller 20 through a metal wire MT. Since each signal source connected to each metal wire MT is independent, the controller 20 can set the voltage level of each unit electrode block 202 through its corresponding metal wire MT, such that the unit electrode block 202 can be used as a common electrode or a touch electrode of the pixels. When the touch display device is operated under the touch mode, the controller 20 can sense the change in the signal outputted from the unit electrode blocks 202 through its corresponding metal wire MT and generate a sensing output signal according to the sensed signal change. By sensing the magnitude of the sensing output signal, the controller 20 can determine whether a touch event occurs and further differentiate the nature of the touch event. For example, the controller 20 can determine whether the touch event is a plane touch event or a pressing touch event.

The metal wire MT and the unit electrode blocks 202 can be implemented on two different layers which are separated by an insulating layer. Each metal wire MT can be electrically connected to its corresponding unit electrode block 202 through multiple via holes VHs penetrating the insulating layer. In an embodiment as indicated in FIG. 2, each unit electrode block 202 can be electrically connected to a plurality of dummy metal wires DM which are electrically isolated from the controller 20. Further, the dummy metal wires DM are equivalent to the metal wires electrically connected to the unit electrode blocks 202. Through the disposition of the dummy metal wires DM, the resistance of the first electrode layer can be reduced, and the overall resistance becomes more uniform.

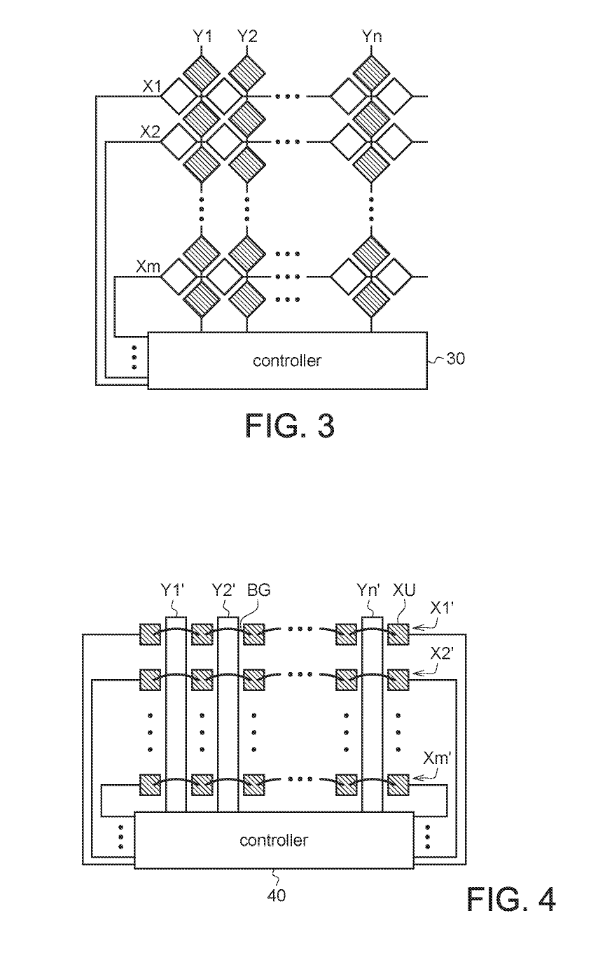

Refer to FIG. 3. In the example illustrated in FIG. 3, the first electrode layer is realized by a mutual-capacitive in-cell touch structure. As indicated in FIG. 3, the first electrode layer includes a plurality of transmitter electrodes X1-Xm and a plurality of receiver electrodes Y1-Yn, wherein both m and n are a positive integer, wherein each of the transmitter electrodes X1-Xm; each of the receiver electrodes Y1-Yn respectively includes a plurality of diamond-shaped or rhomboidal sub-unit electrodes formed by way of patterning. However, the shape of the transmitter electrodes X1-Xm and the receiver electrodes Y1-Yn is not limited thereto.

The transmitter electrodes X1-Xm and the receiver electrodes Y1-Yn are, for example, located on the same plane but are not connected to each other. For example, the overlapping part of the transmitter electrodes X1-Xm and the receiver electrodes Y1-Yn has a bridge portion through which the signals on the transmitter electrodes X1-Xm (or the receiver electrodes Y1-Yn) are transmitted across the receiver electrodes Y1-Yn (or the transmitter electrodes X1-Xn).

The controller 30 is electrically connected to the first electrode layer. When the touch display device is operated under the display mode, the controller 30 can output a first signal (such as a common electrode signal) to the transmitter electrodes X1-Xm and the receiver electrodes Y1-Yn, such that the electrodes X1-Xm and Y1-Yn can be used as common electrodes of the pixels. When the touch display device is operated under the touch mode, the controller 30 can transmit a detection signal to the transmitter electrodes X1-Xm according to a certain order (such as sequentially) and further generate a sensing output signal for determining subsequent touch events according to the change in the signal received from the receiver electrodes Y1-Yn.

Refer to FIG. 4. In the example illustrated in FIG. 4, the first electrode layer is realized by a mutual-capacitive in-cell touch structure. As indicated in FIG. 4, the first electrode layer includes transmitter electrodes X1′-Xm′ and receiver electrodes Y1′-Yn′. The transmitter electrodes X1′-Xm′ and the receiver electrodes Y1′-Yn′ are staggered with each other on the same plane and are connected to the controller 40. In the present embodiment, the receiver electrodes Y1′-Yn′ are arranged in multiple columns, and the transmitter electrodes X1′-′Xm are arranged in multiple rows. Each of the transmitter electrodes X1-Xm respectively includes a plurality of sub-transmitters electrodes XU. The sub-transmitters electrodes XU are electrically connected through the connection wire BG to form a transmitter electrode.

Like the foregoing embodiments, the controller 40 is electrically connected to the first electrode layer. When the touch display device is operated under the display mode, the controller 40 can output a first signal (such as common electrode signal) to the transmitter electrodes X1′-Xm′ and the receiver electrodes Y1′-Yn′, such that the transmitter electrodes X1′-Xm′ and the receiver electrodes Y1′-Yn′ can be used as common electrodes of the pixel transistors. When the touch display device is operated under the touch mode, the controller 40 can transmit a detection signal to the transmitter electrodes X1′-Xm′ according to a certain order (such as sequentially) and generate a sensing output signal for determining subsequent touch events according to the change in the signal received from the receiver electrodes Y1′-Yn′.

It can be understood that the disclosure is not limited to above exemplifications. The first electrode layer can also be realized by electrodes having other patterns or arrangements as long as the first electrode layer can be controlled by the controller and selectively used as a common electrode layer of the pixels or used as a touch electrode layer for sensing touch events.

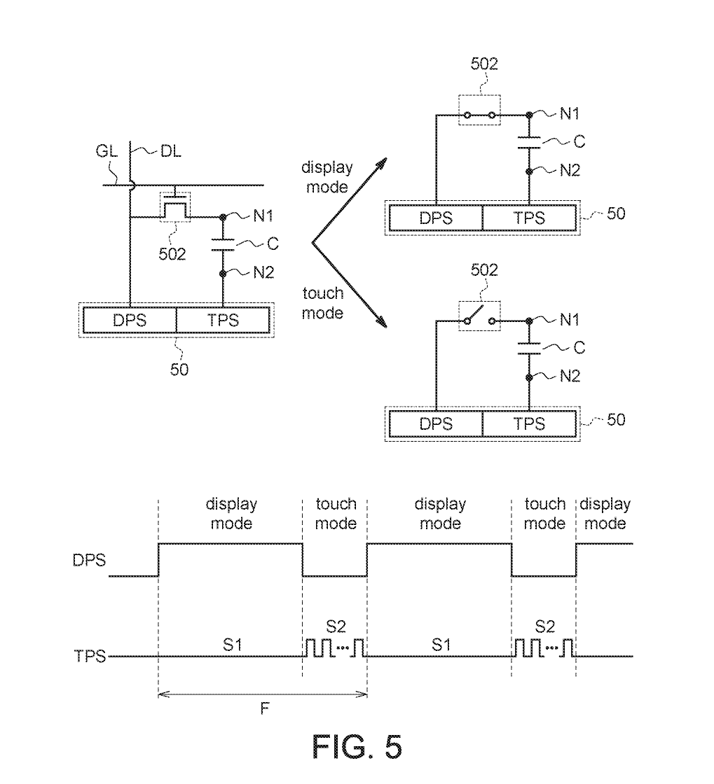

FIG. 5 is an example of a schematic diagram of relevant signal operations for pixel transistors by a controller when the touch display device is operated under different modes. In the present example, the touch display device can be alternately operated between the display mode and the touch mode to achieve touch display function. As indicated in FIG. 5, the touch display device, within a frame of operation time F, is operated under the display mode and the touch mode in sequence. It should be noted that the timing sequence illustrated in FIG. 5 is merely used to make the disclosure easier to understand, not to limit the disclosure. In other embodiments, the touch display device can be selectively operated under the display mode or the touch mode based on any arrangement of timing sequence.

The signal output of the controller 50 can be divided into two parts: the display mode signal DPS and the touch mode signal TPS. When the touch display device is operated under the display mode, the transistors 502 are enabled by the scan lines GL and become turned on; meanwhile, the controller 50 outputs the display mode signal DPS corresponding to the display data to the node N1 through the data lines DL and outputs the touch mode signal TPS (hereinafter referred as the first signal S1) corresponding to the common voltage to the node N2, such that the electrical field of the pixel capacitor C can change in response to the display mode signal DPS to achieve display function. Therefore, when the touch display device is operated under the display mode, the node N1 is used as a pixel electrode, and the node N2 is used as a common electrode.

When the touch display device is operated under the touch mode, transistors 502 are disabled by the scan lines GL and become turned off; meanwhile, the node N1 is in a floating state, and the controller 50 outputs one or more than one enabled touch mode signal TPS (hereinafter referred as the second signal S2) to the node N2 to sense a touch. Therefore, when the touch display device is operated under the touch mode, the node N1 is a floating electrode board, and the node N2 is used as a touch electrode.

The node N2 is located on the first electrode layer (such as the first electrode layer EL1 of FIG. 1). After receiving different signals, such as the first signal S1 or the second signal S2, the node N2 will be correspondingly used as a common electrode of the pixels or a touch electrode for detecting a touch event.

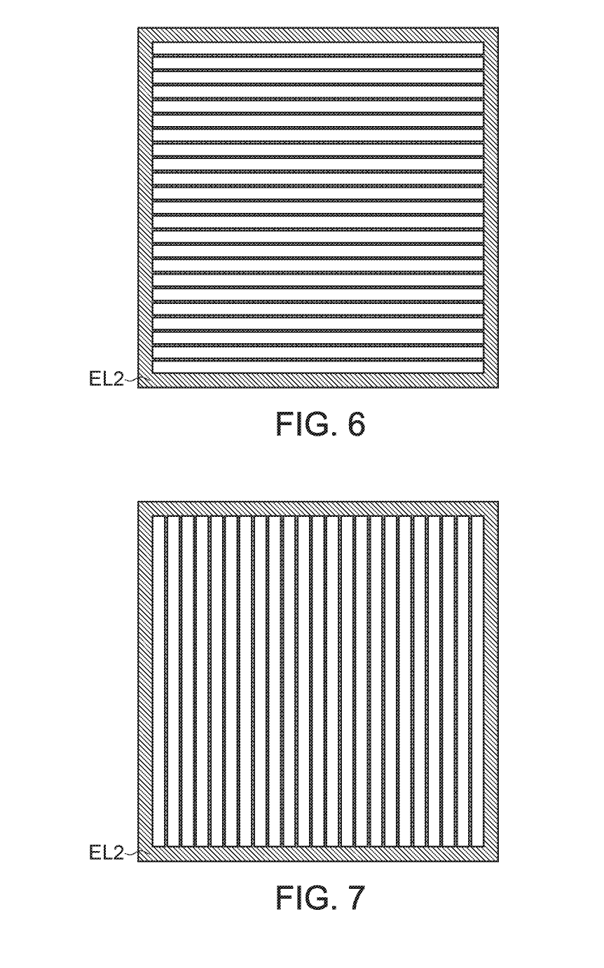

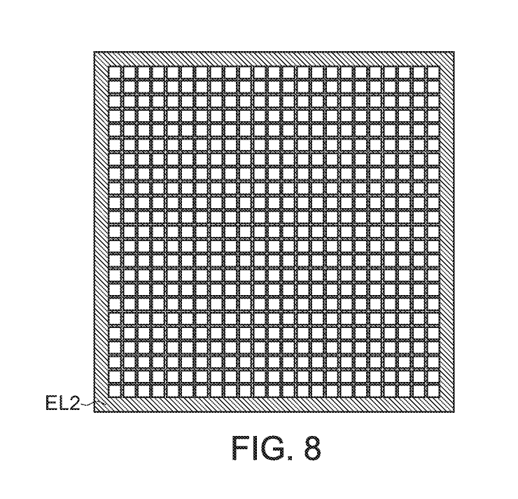

As disclosed above, a capacitor can be formed between the first electrode layer and the second electrode layer to effectively amplify the sensing output signal generated when the touch display device is pressed. In an embodiment of the disclosure, as shown in FIGS. 6-8, the second electrode layer EL2 can be realized by different electrode patterns. When the transistors of the first substrate layer are electrically connected to a plurality of data lines (such as a data lines DL of FIG. 5) and a plurality of scan lines (such as a scan lines GL of FIG. 5) and the data lines and the scan lines are crossed with each other, the electrode pattern of the second electrode layer EL2 FIG can overlap or parallel with the scan lines (such as FIG. 6) or the data lines (such as FIG. 7) or both the scan lines and the data lines at the same time to form a grid pattern (such as FIG. 8).

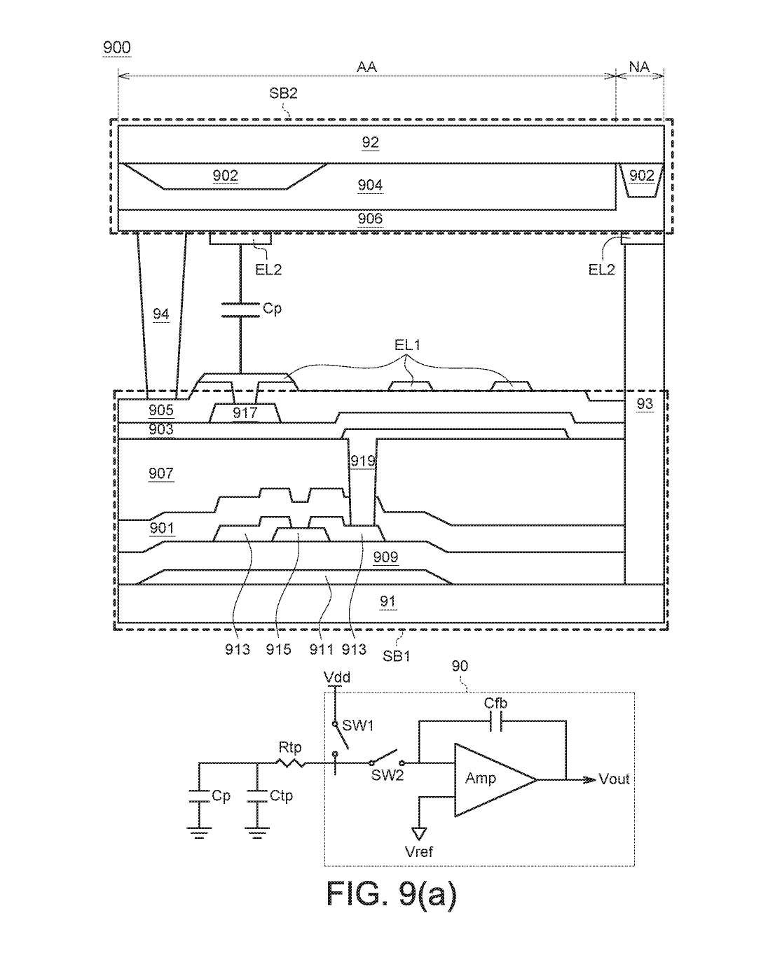

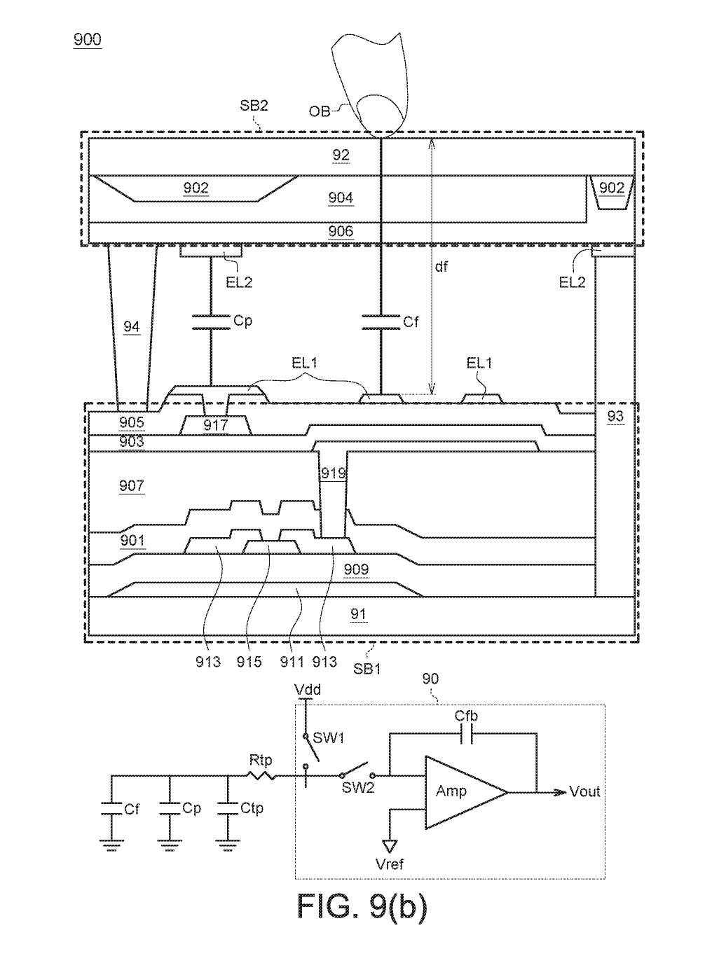

FIGS. 1, 2, 9(a), 9(b), 10, refer to a first embodiment of the disclosure. FIG. 9(a) is a cross-sectional view of a touch display device 900 according to the first embodiment of the disclosure. For the convenience of explanation, elements of the touch display device 900 similar to or identical to that of above embodiments retain the same designations.

The touch display device 900 includes a first substrate layer SB1, a second substrate layer SB2, a first electrode layer EL1 and a second electrode layer EL2. The first substrate layer SB1 includes a substrate 91, insulating layers 901, 903 and 905, a flat layer 907, a gate insulating layer 909, a gate electrode layer 911 of the transistors, a source/drain layer 913 of the transistors, an active layer 915 (such as formed of amorphous silicon or an oxide semiconductor material) of the transistors, a metal wire layer 917 and a pixel electrode 919 (such as an indium tin oxide (ITO) electrode).

The touch display device 900 is a top common structure in which the common electrode (the first electrode layer EL1) is formed above the pixel electrode 919. In an embodiment, the first substrate layer SB1 and the first electrode layer EL1 formed thereon can be formed by following manufacturing process. The metal of the gate electrode layer 911 is deposited and patterned on the substrate 91. The gate insulating layer 909 and the active layer 915 are deposited, and the active layer 915 is patterned. The source/drain layer 913 is deposited and is patterned to form a plurality of source wires/drain wires/data lines, wherein a part of the source/drain layer 913 is electrically connected to the active layer 915. After the insulating layer 901 (the first passivation layer) and the flat layer 907 are deposited, the insulating layer 901 (the first passivation layer) and the flat layer 907 are patterned to form a via hole reaching the source/drain layer 913. The pixel electrode 919 is deposited and patterned, such that the pixel electrode 919 can be used as a pixel electrode of the touch display device 900 and be electrically connected to the source/drain layer 913 (such as the drain of the pixel transistor) through the via hole. The insulating layer 903 (the second passivation layer) is deposited. The metal wire layer 917 is deposited, such that the metal wire layer 917 can be used as traces for transmitting the common electrode voltage and the touch signal to the first electrode layer EL1. The metal wire layer 917 is patterned to overlap with the data lines of the source/drain layer 913. The insulating layer 905 (the third passivation layer) is deposited and is patterned to form a via hole above the metal wire layer 917. The first electrode layer EL1 is deposited and is patterned to form slits, such that the first electrode layer EL1 can be used as a common electrode and a touch electrode of the touch display device and be connected to the metal wire layer 917 through the via hole (such as the via hole VH of FIG. 2).

The second substrate layer SB2 includes a substrate 92, a black matrix 902, a color filter 904 and an overcoat 906. In an embodiment, the second substrate layer SB2 and the second electrode layer EL2 formed thereon can be formed by following manufacturing process. A black matrix 902 is disposed on a substrate 92 and patterned. Pigments R, B and G are disposed on the substrate 92 and are patterned respectively. An overcoat 906 is disposed on the color filter 904 and the black matrix 902. A second electrode layer EL2 (transparent/non-transparent electrode) is deposited and patterned. A photo resist of the photo spacer 94 is coated and patterned on the second substrate SB2. The second electrode layer EL2 is interposed between the black matrix 902 and the first electrode layer EL1 and located within the optical shielding area formed by the black matrix 902 so as not to affect the distribution of the electrical field within the display area and not to deteriorate the display quality. In other embodiments, the photo spacer is coated and patterned on the first substrate layer SB1. It should be noted that the color filter and the black matrix may be omitted in an OLED device.

Then, the first substrate layer SB1 and the second substrate layer SB2 are assembled together to form a capacitor Cp between the first and the second electrode layers EL1 and EL2. The capacitance of the capacitor Cp can vary with the change in the gap generated when the touch display device is pressed.

In an embodiment, the touch display device 900 further includes a connection element 93 located within a non-display area NA (such as outside the active area AA) of the touch display device 900, such that the second electrode layer EL2 can be electrically connected to the first substrate layer SB1. It should be noted that the connection element 93 is not limit to contact the substrate 91. The connection element 93 can contact one of the layers of the first substrate layer SB1 other than the substrate 91. The connection element 93 can be realized by an Au ball, an anisotropic conductive film (ACF), silver glue, conductive particles on sealant, conductive particles on frit or other suitable electric connection methods or conductive materials. The voltage of the second electrode layer EL2 can be set through the connection element 93. For example, the voltage of the second electrode layer EL2 can be set as the voltage of the first signal S1 (such as a voltage of the common electrode), the voltage of the second signal S2 (such as the voltage of a sensing signal), a ground voltage or other specific voltages. Or, the touch display device 900 does not include the connection element 93, and the voltage of the second electrode layer EL2 is in a floating state.

The bottom of FIG. 9(a) is an equivalent circuit diagram of a metal wire formed of a metal wire layer 917 and a controller 90 connected thereto. In the present example, the metal wire has an equivalent resistor Rtp, and an equivalent capacitor Ctp is formed on the disposition path of the metal wire (that is, the sum of the capacitors formed between the metal wire and other electrode/metal layer), and a capacitor Cp is formed between the first conductive layer EL1 and the second conductive layer EL2. The controller 90 includes a first switch SW1, a second switch SW2, an amplifier Amp and a feedback capacitor Cfb. The first switch SW1 and the second switch SW2 are alternately turned on/off to charge/discharge the capacitors Ctp and Cp. Further, one end of the first switch SW1 is coupled to the power Vdd. When the first switch SW1 is turned on, the second switch SW2 will be turned off; meanwhile, the power Vdd will charge the capacitors Ctp and Cp. Conversely, when the second switch SW2 is turned on, the first switch SW1 will be turned off; meanwhile, the charges accumulated at the capacitors Ctp and Cp will be outputted to an input end of the amplifier Amp, and the other input end of the amplifier Amp will be coupled to the reference voltage Vref. A feedback capacitor Cfb formed by the input end and the output end of the amplifier Amp to meet the requirements of circuit stability and bandwidth. The amplifier Amp can generate a sensing output signal Vout in response to the signals outputted from the metal wire. The sensing output signal Vout can be detected from an output end of the controller 90 and the wave-pattern of a sensing output signal Vout can be analyzed by an oscilloscope. When no touch event occurs, the sensing output signal Vout can be expressed as:

$$Vout = \frac{Ctp + Cp}{Cfb} \times ( Vdd - Vref ) \times n \qquad ( Formula 1 )$$

Wherein n represents the number of sensing cycles, and n is a positive integer.

Refer to FIG. 9(b), a schematic diagram of a touch event on a touch display device 900 is shown. As indicated in FIG. 9(b), when an object OB (such as a finger, a stylus or any object that can be used in a touch operation) touches the touch display device 900, a sensing capacitor Cf will be generated between the object OB and the first electrode layer EL1 of the touch display device 900. Meanwhile, relevant equivalent circuits are illustrated at the bottom of FIG. 9(b). In FIG. 9(b), a sensing capacitor Cf is formed on the metal wire. Therefore, when the touch event occurs, the sensing output signal Vout can be expressed as:

$$Vout = \frac{Ctp + Cp + Cf}{Cfb} \times ( Vdd - Vref ) \times n \qquad ( Formula 2 )$$

Wherein n represents the number of sensing cycles, and n is a positive integer.

Wherein, the capacitance of the sensing capacitor Cf is inversely correlated with the gap df between the object OB and the first electrode layer EL1. That is, when the object OB is pressed and the gap df becomes smaller, the capacitance of the sensing capacitor Cf will increase and the sensing output signal Vout will also increase.

In general, when a touch event occurs but the object OB is farther away from the first electrode layer EL1, for example, the sensing capacitor Cf caused by the object OB is about 1 pF, it is not easy for the controller 90 to determine the magnitude of the pressing force solely according to the change in the capacitance of the sensing capacitor Cf which varies with the magnitude of the pressing force. In an embodiment of the disclosure, a relatively large capacitor Cp can be formed between the first electrode layer EL1 and the second electrode layer EL2 which is disposed on the inner side of the second substrate layer SB2. Moreover, the size of the capacitor is determined according to the design needs and the capacitance of the capacitor can vary significantly with the magnitude of the pressing force. Therefore, the controller 90 can determine whether the touch event is a plane touch event or a pressing touch event according to the generated sensing output signal Vout.

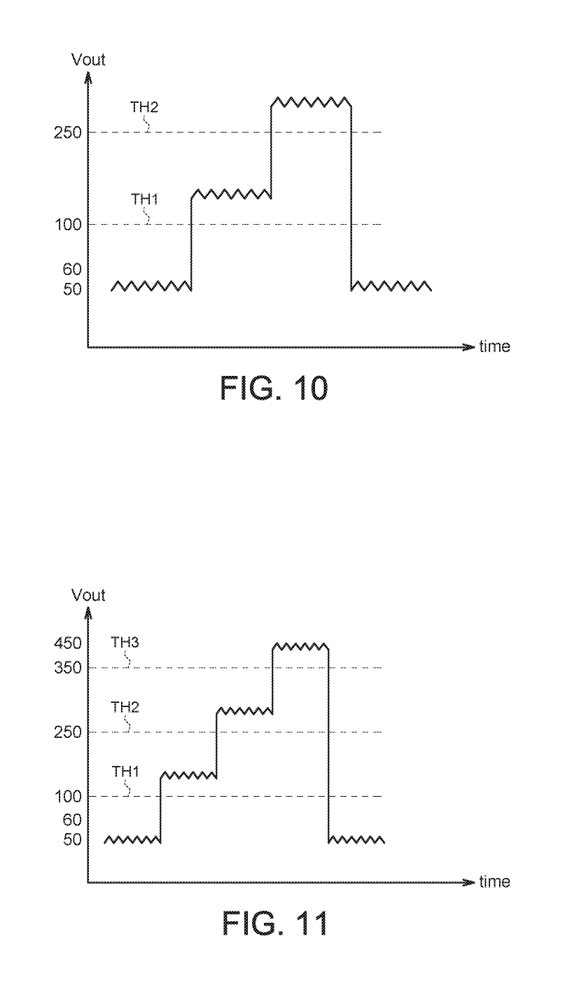

FIG. 10 is an example of a wave-pattern of a sensing output signal Vout. In the present example, suppose the capacitance of the sensing capacitor Cf caused by the object is 1 pF, the capacitance of the capacitor Cp is 6 pF, and the gap between the first and the second electrode layers EL1 and EL2 is d when plane touch event occurs. If the object OB touches the touch display device and makes the sensing capacitor Cf become larger and causes the value of the sensing output signal Vout to increase from 50 to 150 (here, the value of the sensing output signal Vout is unit free and is used to indicate the magnitude relationship of the signals), and meanwhile, the value of the sensing output signal Vout is over the first threshold TH1 (for example, the corresponding signal value is 100), the controller can determine that a touch event occurs.

When the object OB heavily presses the touch display device and makes the gap become ⅔d, the capacitance of the capacitor Cp will be amplified to 9 pF, and the value of the sensing output signal Vout will exceed 250. The increase in signal value allows the controller to determine one or more than one touch state. As indicated in FIG. 10, the controller can determines whether the touch event is a plane touch event or a pressing touch event according to whether the value of the sensing output signal Vout is over the second threshold TH2 (larger than the first thresholds TH1; the corresponding signal value is 250). That is, if the value of the sensing output signal Vout is lower than the first thresholds TH1, then the controller determines that no touch event occurs. If the value of the sensing output signal Vout is between the first threshold TH1 and the second threshold TH2, then the controller determines that a plane touch event occurs (an ordinary operation such as sliding or light touch, not an operation of heavy pressing with a large force). If the value of the sensing output signal Vout is over the second threshold TH2, then the controller determines that a pressing touch event occurs (an operation of heavy pressing with a large force).

It can be understood that the values of various parameters mentioned in above exemplifications, such as magnitude of the capacitance, level of the threshold and signal value, are merely used to make the disclosure easier to understand, not to limit the disclosure. In practical application, the design of the capacitors Cp and Cf varies with the circuit structure, and threshold level is set according to the considerations of sensing sensitivity and field of applications.

As disclosed above, when the object OB heavily presses the touch display device and makes the gap d change, the capacitance of the capacitor Cp will change and so will the value of the sensing output signal Vout change accordingly. Thus, the controller can determine that a pressing touch event occurs. Therefore, the object OB can be used as an insulating object in addition to being used as a conducting object, and the controller can further determine the position at which the plane touch event occurs according to the pressing touch event.

FIG. 11 is another example of a wave-pattern of a sensing output signal. The present embodiment is different from previous embodiments in that in the present embodiment, the controller further determines the pressure state corresponding to the pressing touch event according to a second threshold TH2 and a third threshold TH3. As indicated in FIG. 11, the controller further determines whether the sensing output signal Vout is over the third threshold (for example, the corresponding signal value is 350). If yes, the controller determines that the pressing touch event corresponds to a heavy pressing state. If the value of the sensing output signal Vout is between the second threshold TH2 and the third threshold TH3, the controller can determine that the pressing touch event is an ordinary pressing state. However, the disclosure is not limited thereto. In other embodiments, the controller can further divide the pressing touch event into more pressure states according to more thresholds and the rear-end circuit will perform corresponding processing.

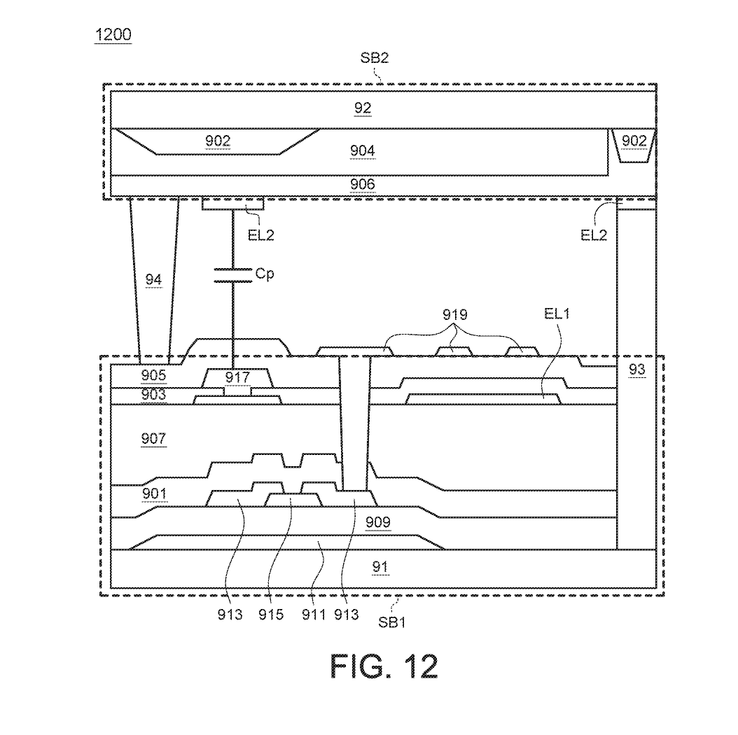

FIG. 12 is a cross-sectional view of a touch display device 1200 according to an embodiment of the disclosure. For the convenience of explanation, elements of the touch display device 1200 similar to or identical to that of above embodiments retain the same designations. Designations common to the accompanying drawings are used to indicate identical or similar elements.

The touch display device 1200 is different from the touch display device 900 mainly in that: the touch display device 1200 is a top pixel structure in which the pixel electrode 919 is formed above the common electrode (the first electrode layer EL1). As indicated in FIG. 12, the pixel electrode 919 is formed between the first electrode layer EL1 and the second electrode layer EL2 and is electrically connected to the transistors of the first substrate layer SB1. Relevant signal operations and determination of touch events of the touch display device 1200 are similar to that of the above embodiments, and are not repeated here.

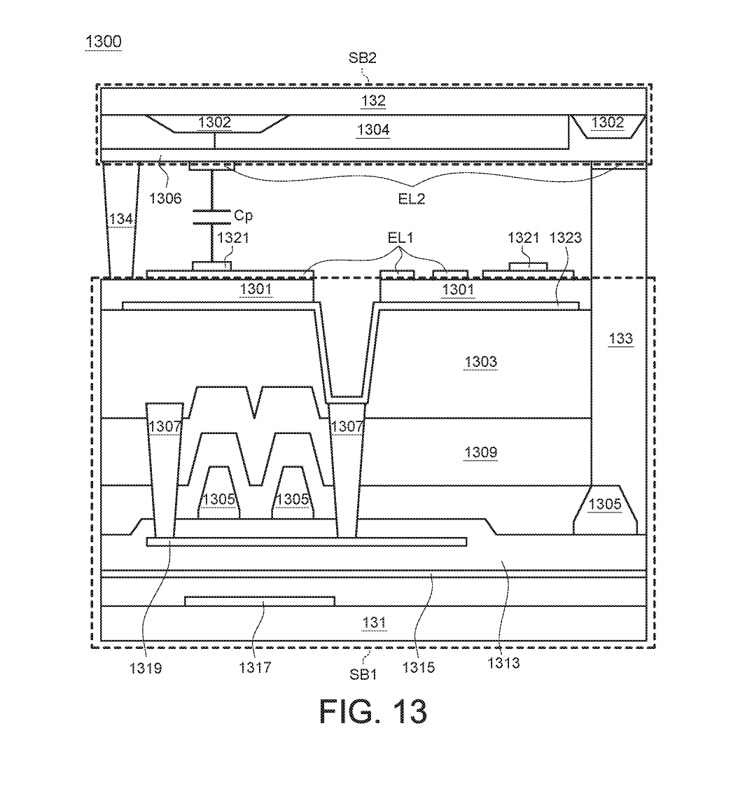

FIG. 13 is a cross-sectional view of a touch display device 1300 according to an embodiment of the disclosure. For the convenience of explanation, elements of the touch display device 1300 similar to or identical to that of above embodiments retain the same designations.

The touch display device 1300 includes a first substrate layer SB1, a second substrate layer SB2, a first electrode layer EL1 and a second electrode layer EL2. The first substrate layer SB1 includes a substrate 131, an insulating layer 1301, a flat layer 1303, a gate electrode layer 1305, a source/drain layer 1307, insulating layers 1309 and 1311, a gate insulating layer 1313, a buffer layer 1315, a light shielding layer 1317, an active layer 1319 formed of low temperature poly-silicon (LTPS), a metal wire layer 1321 and a pixel electrode 1323. The metal wire layer 1321 is used as traces for transmitting the common electrode voltage and touch signals to the first electrode layer EL1. The first electrode layer EL1, in response to the signals outputted from the metal wire layer 1321, is used as a common electrode of the pixels or a touch electrode for sensing a touch event. For example, illustratively but not restrictively, the first electrode layer EL1 can be realized by the electrodes of FIG. 4. Meanwhile, the metal wire of the metal wire layer 1321 can be realized by the transmitter electrodes X1′-Xm′ or the receiver electrodes Y1′-Yn′.

The second substrate layer SB2 of the touch display device 1300 includes a substrate 132, a black matrix 1302, a color filter 1304 and an overcoat 1306. The first electrode layer EL1 forms a capacitor Cp with the second electrode layer EL2, which is formed on the inner side of the second substrate layer SB2.

Display medium can be formed between the first substrate layer SB1 and the second substrate layer SB2, and the two substrate layers can be separated by a photo spacer 134. In an embodiment, the touch display device 1300 further includes a connection element 133 located within a non-display area NA of the touch display device 1300, and the second electrode layer EL2 is electrically connected to the first substrate layer SB1 through the connection element 133. Through the connection element 133, the voltage of the second electrode layer EL2 can be set as a common electrode voltage, a signal sensing voltage, a ground voltage or other specific voltages. Or, the touch display device 1300 does not include the connection element 133, and the voltage of the second electrode layer EL2 is in a floating state. It should be noted that the connection element 133 is not limit to contact the gate electrode layer 1305. The connection element 93 can contact one of the layers of the first substrate layer SB1 other than the gate electrode layer 1305.

Relevant signal operations and determination of touch events of the touch display device 1300 are similar to that of the above embodiments, and are not repeated here.

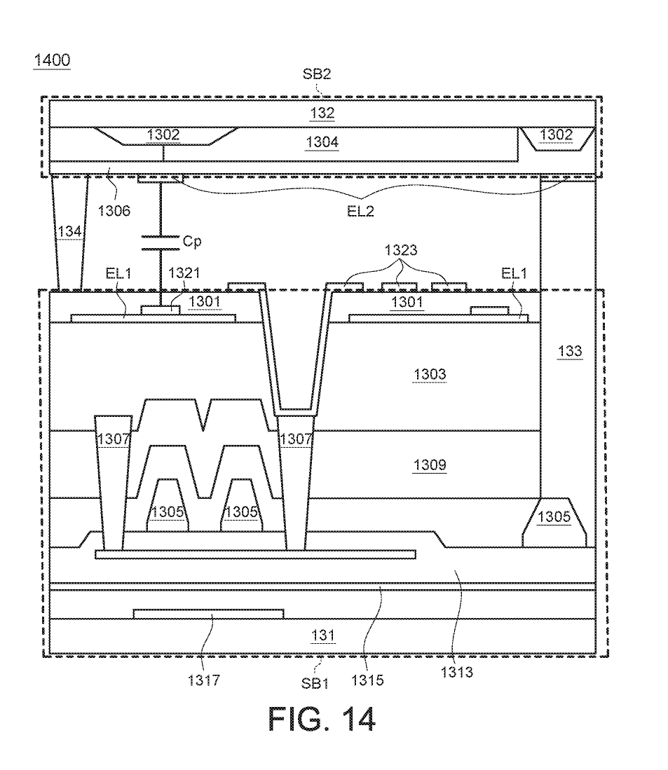

FIG. 14 is a cross-sectional view of a touch display device 1400 according to an embodiment of the disclosure. For the convenience of explanation, elements of the touch display device 1400 similar to or identical to that of above embodiments retain the same designations.

The touch display device 1400 is different from the touch display device 1300 mainly in that: the touch display device 1300 adopts a top common structure, but the touch display device 1400 adopts a top pixel structure. As indicated in FIG. 14, the pixel electrode 1323 is formed above the first electrode layer EL1 and is electrically connected to a transistor structure underneath. Relevant signal operations and determination of touch events of the touch display device 1400 are similar to that of the above embodiments, and are not repeated here.

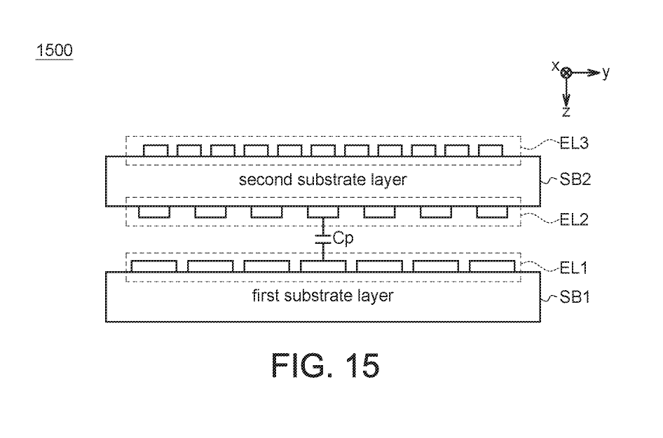

FIG. 15 is a cross-sectional view of a touch display device 1500 according to an embodiment of the disclosure. In the present embodiment, the touch electrode layer EL3 for sensing plane touch (touch or light touch along the x direction or the y direction) is disposed on the side of the second substrate layer opposite to the second electrode layer EL2.

Therefore, the controller of the touch display device 1500 can detect a plane touch event by sensing a change in the signal outputted from the touch electrode layer EL3, and detect a pressing touch event by sensing a change in the signal outputted from the first electrode layer EL1 (such as pressing along the z direction). The touch electrode layer EL3 can be realized by various touch receiver electrodes such as the capacitive receiver electrodes of FIG. 3.

In the present embodiment, the first electrode layer EL1 includes a plurality of receiver electrodes, the second electrode layer EL2 includes common electrodes biased at a certain voltage (e.g., Vcom), and the first electrode layer EL1 together with the second electrode layer EL2 can be used for sensing a pressing touch event. Further, the third electrode layer EL3 includes a plurality of transmitter electrodes and receiver electrodes for sensing a plane touch event.

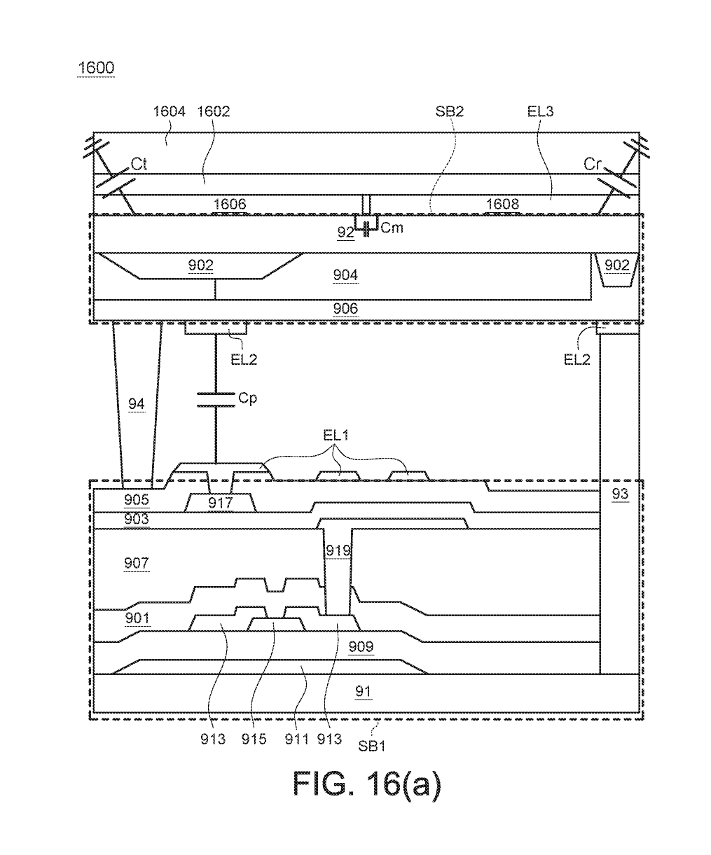

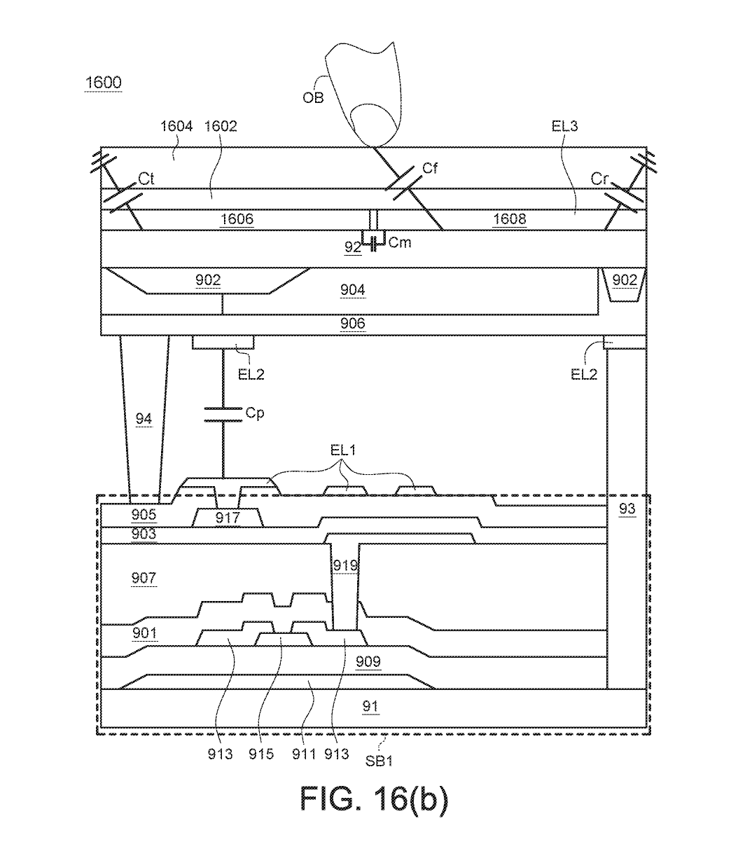

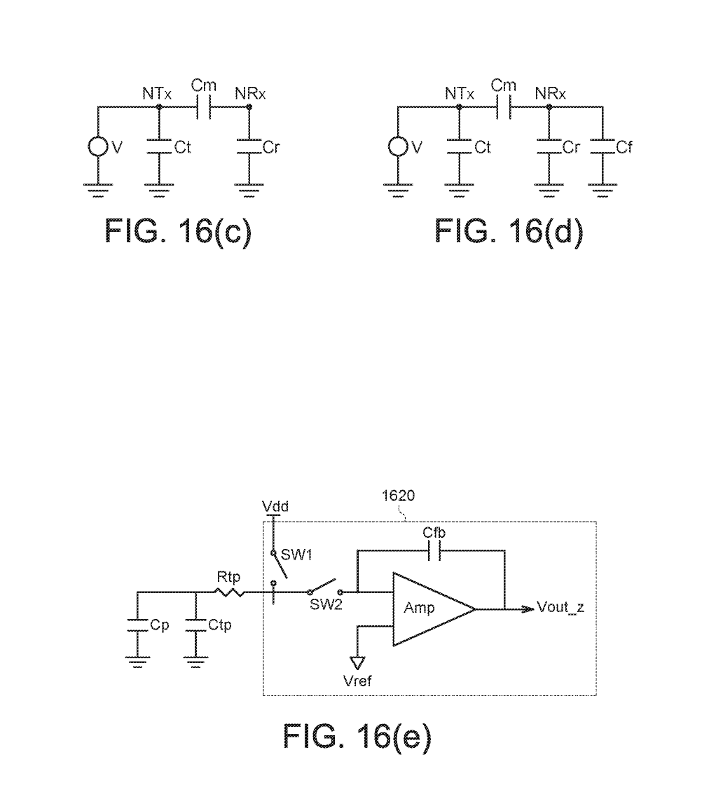

FIGS. 15, 16(a), 16(b), 16(c), 16(d), 16(e), 17, and 18 refer to a second embodiment of the disclosure. FIG. 16(a) is a cross-sectional view of a touch display device 1600 according to the second embodiment of the disclosure. For the convenience of explanation, elements of the touch display device 1600 similar to or identical to that of above embodiments retain the same designations.

The side of the second substrate layer SB2 of the touch display device 1600 opposite to the second electrode layer EL2 further includes a third electrode layer EL3. The third electrode layer EL3 has a dielectric layer 1602 (such as an optically clear adhesive/resin layer or an air layer) disposed thereon. The dielectric layer 1602 has a cover glass 1604 disposed thereon. The third electrode layer EL3 can be realized by the capacitive touch electrode of FIG. 3, and includes a transmitter electrode 1606 used as a transmitter electrode layer (Tx) and a receiver electrode 1608 used as a receiver electrode layer (Rx). The transmitter electrode 1606 and the receiver electrode 1608 are mainly used for detecting a plane touch event.

Refer to FIG. 16(b) and FIG. 16(c). FIG. 16(b) is a cross-sectional view of a touch display device 1600 when a touch event occurs. FIG. 16(c) is a relevant equivalent circuit diagram of a touch display device 1600 when no touch event occurs.

In the present example, the controller 1610 (not illustrated in the diagram) connects the third electrode layer EL3, and is mainly used for detecting the plane touch event. The controller 1620 connects the first electrode layer EL1, and is mainly used for detecting a pressing touch event. Based on the design needs, the controllers 1610 and 1620 can be implemented on different circuits or integrated on the same circuit.

The metal wire connected to the controller 1610 has an equivalent resistor Ra (not illustrated in the diagram). The transmitter electrode 1606 forms a capacitor Ct with respect to the ground. The receiver electrode 1608 forms a capacitor Cr with respect to the ground. An equivalent capacitor Cm is formed between the receiver electrode 1608 and the transmitter electrode 1606. When a touch event occurs, that is, when the object OB touches one side of the cover glass 1604, a capacitor Cf will be formed between the object OB and the third electrode layer EL3.

FIGS. 16(c)-16(d) are relevant equivalent circuit diagrams of the touch display device 1600 shown in FIGS. 16(a) and 16(b) when no touch event occurs and when a plane touch event occurs respectively. NTx and NRx respectively represent the node located on the transmitter electrode layer 1606 and the node located on the receiver electrode layer 1608. Suppose the voltage at the node NTx is V. The voltage V can be expressed as expressed as:

V=Vm+Vr (Formula 3)

Wherein, Vm represents the cross-voltage crossing the two ends of the capacitor Cm; Vr represents the cross-voltage crossing the two ends of the capacitor Cr.

FIG. 16(c) is a relevant equivalent circuit diagram of a touch display device 1600 when no touch event occurs.

When no touch event occurs, the cross-voltage Vr crossing the two ends of the capacitor Cr can be expressed as:

$$Vr = \frac{Cm}{Cr + Cm} \times V \qquad ( Formula 4 )$$

The cross-voltage Vm crossing the two ends of the capacitor Cm can be expressed as:

$$Vm = \frac{Cr}{Cr + Cm} \times V \qquad ( Formula 5 )$$

Meanwhile, the sensing output signal Vout generated by the controller according to the signal of the node NRx can be expressed as:

$$Vout = Vr \times n = \frac{Cm}{Cr + Cm} \times V \qquad ( Formula 6 )$$

Wherein n represents the number of sensing cycles, and n is a positive integer.

Refer to FIG. 16(d). FIG. 16(d) is a relevant equivalent circuit diagram of a touch display device 1600 when a plane touch event occurs. As indicated in FIG. 16(d), when a plane touch event occurs, a capacitor Cf will be formed at the node NRx due to the touch event. Meanwhile, the cross-voltage Vr crossing the two ends of the capacitor Cr can be expressed as:

$$Vr = \frac{Cm}{Cr + Cm + Cf} \times V \qquad ( Formula 7 )$$

The cross-voltage Vm crossing the two ends of the capacitor Cm can be expressed as:

$$Vm = \frac{Cr + Cf}{Cr + Cm + Cf} \times V \qquad ( Formula 8 )$$

The sensing output signal Vout generated by the controller according to the signal of the node NRx can be expressed as:

$$Vout = Vr \times n = \frac{Cm}{Cr + Cm + Cf} \times V \times n \qquad ( Formula 9 )$$

Wherein n represents the number of sensing cycles, and n is a positive integer.

In comparison to Formula 6, it can be known that the capacitor Cf generated due to the touch event will make the sensing output signal Vout become smaller.

As shown in FIG. 16(e), the controller 1620 can detect a pressing touch event according to the change in the capacitance of the capacitor Cp. The sensing output signal Vout_z can be detected from an output end of the controller 1620 and the wave-pattern of a sensing output signal Vout can be analyzed by an oscilloscope. It should be noted that in the present example when the object OB touches one side of the cover glass 1604, the capacitor effect (such as the capacitor Cf) generated on the first electrode layer EL1 by the object OB will be shielded by the mutual capacitance effect (such as the capacitor Cm) generated on the third electrode layer EL3. Therefore, the sensing output signal Vout_z generated by the controller 1620 in response to the touch event can be expressed as:

$$Vout\_z = \frac{Ctp + Cp}{Cfb} \times ( Vdd - Vref ) \times n \qquad ( Formula 10 )$$

Wherein n represents the number of sensing cycles, and n is a positive integer.

When the object OB heavily presses the touch display device and reduces the distance between the first substrate layer SB1 and the second substrate layer SB2, the capacitance of the capacitor Cp will become larger and make the value of the sensing output signal Vout_z increase significantly. The increase in signal value allows the controller 1620 to determine one or more than one touch state (such as light pressing state or heavy pressing state).

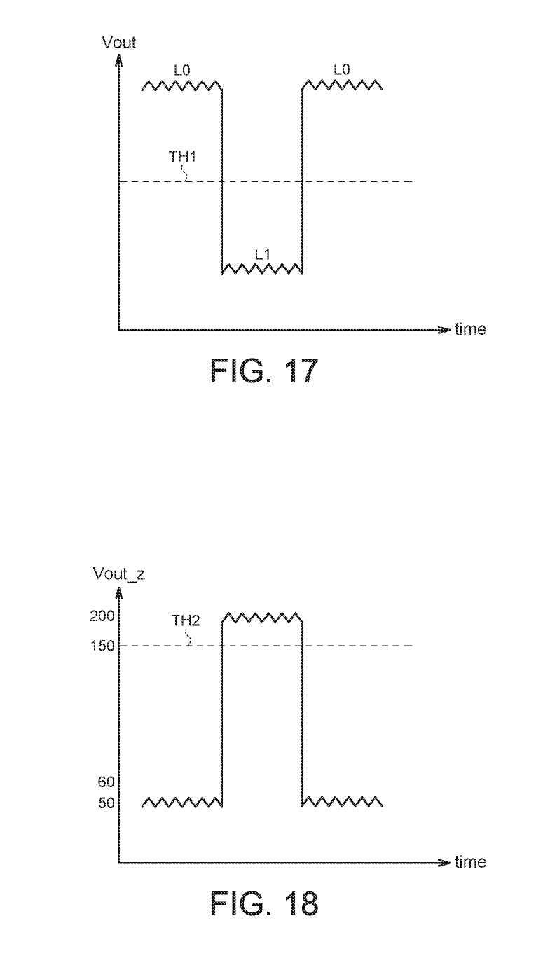

FIG. 17 is an example of a wave-pattern of a sensing output signal Vout. When no touch event occurs, the value of the sensing output signal Vout is L0, which is higher than the first threshold TH1. When a simple plane touch event occurs (not heavy pressing), the value of the sensing output signal Vout will become L1, which is lower than the first threshold TH1.

In the present example, suppose the capacitance of the capacitor Cp is 6 pF before the touch display device is pressed, and the minimum gap d between the first and the second electrode layers EL1 and EL2 is ⅔d after the touch display device is pressed. When the object OB heavily presses the touch display device, the gap d will become ⅔ times of its original size. Meanwhile, the capacitance of the capacitor Cp will be amplified to 9 pF which is 3 pF higher than the original one, and the value of the sensing output signal Vout_z increases from 50 to 200. The increase in signal value (the signal value increases by 150) allows the controller to determine that a pressing touch event occurs. Since the value of the sensing output signal Vout_z is over the first threshold TH2 (for example, the corresponding signal value is 150), the controller can determine that a plane touch event occurs. Another example of a wave-pattern of a sensing output signal Vout_z is illustrated in FIG. 18.

It can be understood that the values of various parameters mentioned in above exemplifications, such as magnitude of the capacitance, level of the threshold and signal value, are merely used to make the disclosure easier to understand, not to limit the invent.

As disclosed above, when the object OB heavily presses the touch display device and makes the gap d change, the capacitance of the capacitor Cp will change and so will the value of the sensing output signal Vout change accordingly. Thus, the controller can determine that a pressing touch event occurs. Therefore, the object OB can be used as an insulating object in addition to being used as a conducting object, and the controller can further determine the position at which the plane touch event occurs according to the pressing touch event.

Refer to FIG. 1. In an embodiment, the first electrode layer EL1 is used as a receiver electrode layer, and the second electrode layer EL2 is used as a transmitter electrode layer. The transmitter electrode layer is used for transmitting sensing signals to detect a touch event. The receiver electrode layer is used for providing signals for the controller to determine whether the touch event occurs and differentiate the nature of the touch event (such as a plane touch event or a pressing touch event). However, the disclosure is not limited thereto. In an embodiment, the first electrode layer EL1 is used as a transmitter electrode layer, and the second electrode layer EL2 is used as a receiver electrode layer. In another embodiment, the first electrode layer EL1 is used as a receiver electrode layer and a transmitter electrode layer as indicated in FIGS. 3 and 4.

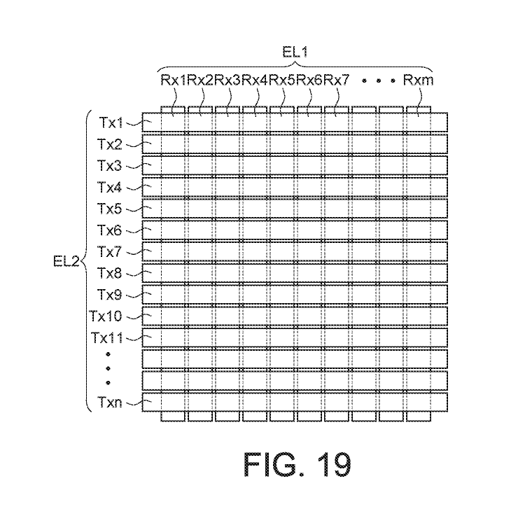

FIGS. 19, 20, 21, 22(a), 22(b), 23, and 24 refer to a third embodiment of the disclosure. FIG. 19 is an example of a top view of a first electrode layer EL1 and a second electrode layer EL2. In the example illustrated in FIG. 19, the first electrode layer EL1 and the second electrode layer EL2 are used as a receiver electrode layer and a transmitter electrode layer respectively.

As indicated in FIG. 19, the first electrode layer EL1 is patterned as a plurality of receiver electrodes Rx1-Rxm electrically isolated from each other. The second electrode layer EL2 is patterned as a plurality of transmitter electrodes Tx1-Txn electrically isolated each other, wherein m, n are positive integers. The receiver electrodes Rx1-Rxm are arranged in multiple columns, and the transmitter electrodes Tx1-Txn are arranged in multiple rows. For example, the receiver electrodes Rx1-Rxm are parallel with the data lines of the pixel matrix and overlap with the light shielding layer. The transmitter electrodes Tx1-Txn disposed on one side of the second substrate layer SB2 are parallel with the gate lines of the pixel matrix and overlap with the light shielding layer.

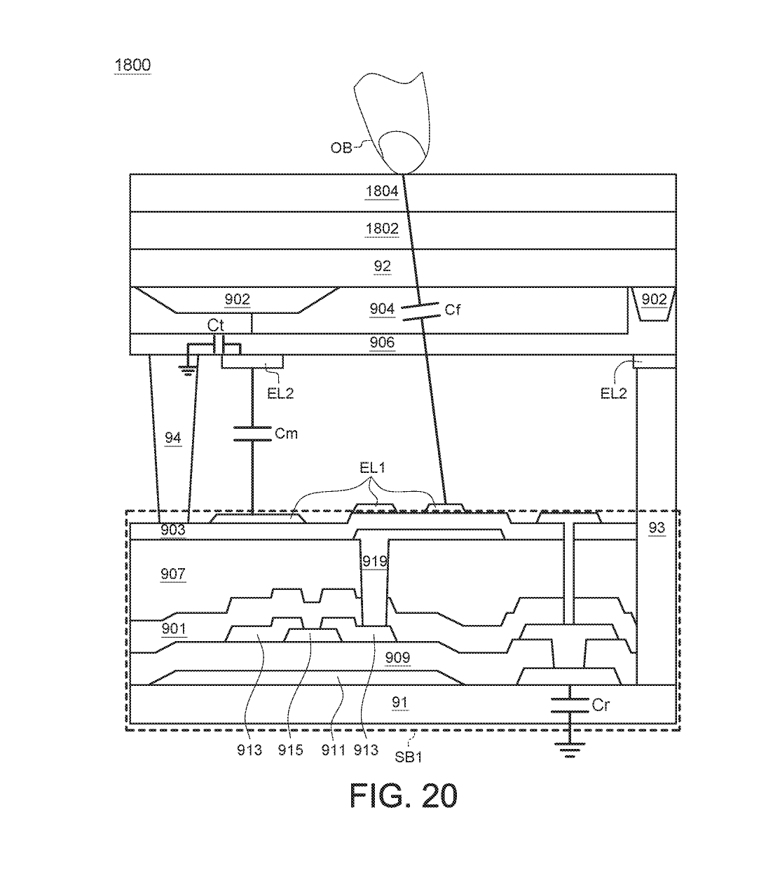

FIG. 20 is an example of a cross-sectional view of a touch display device 1800 when a touch event occurs according to an embodiment of the disclosure. The touch display device 1800 is similar to the touch display device 900 adopting a top common structure. For the convenience of explanation, elements of the touch display device 1800 similar to or identical to that of above embodiments retain the same designations.

The substrate 92 of the touch display device 1800 has a dielectric layer 1802 (such as an optically clear adhesive/resin layer or an air layer) disposed thereon, and the dielectric layer 1802 has a cover glass 1804 disposed thereon. In the present example, the second electrode layer EL2 is used as a transmitter electrode layer, and the first electrode layer EL1 is used as a receiver electrode layer. The second electrode layer EL2 forms a capacitor Ct with respect to the ground. The first electrode layer EL1 forms a capacitor Cr with respect to the ground. A capacitor Cm is formed between the first electrode layer EL1 and the second electrode layer EL2. When the object OB touches the touch display device 1800, a capacitor Cf will be generated between the object OB and the first electrode layer EL1.

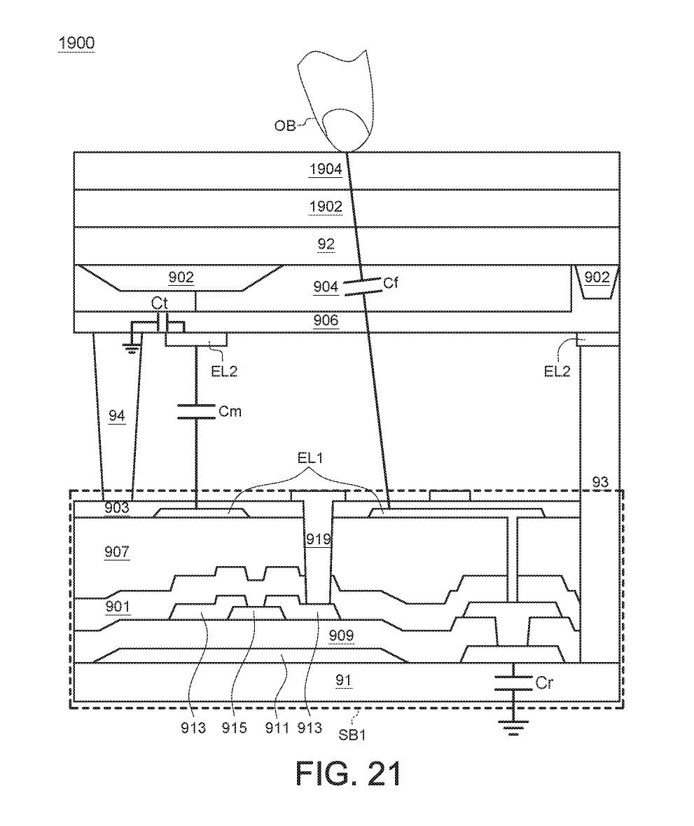

FIG. 21 is an example of a cross-sectional view of a touch display device 1800 when a touch event occurs according to an embodiment of the disclosure. The touch display device 1900 is similar to the touch display device 1200 adopting a top pixel structure. For the convenience of explanation, elements of the touch display device 1900 similar to or identical to that of above embodiments retain the same designations.

The substrate 92 of the touch display device 1900 has a dielectric layer 1902 (such as an optically clear adhesive/resin layer or an air layer) disposed thereon, and the dielectric layer 1902 has a cover glass 1904 disposed thereon. In the present example, the second electrode layer EL2 is used as a transmitter electrode layer, and the first electrode layer EL1 is used as a receiver electrode layer. The second electrode layer EL2 forms a capacitor Ct with respect to the ground. The first electrode layer EL1 forms a capacitor Cr with respect to the ground. A capacitor Cm is formed between the first electrode layer EL1 and the second electrode layer EL2. When the object OB touches the touch display device 1900, a sensing capacitor Cf will be generated between the object OB and the first electrode layer EL1.

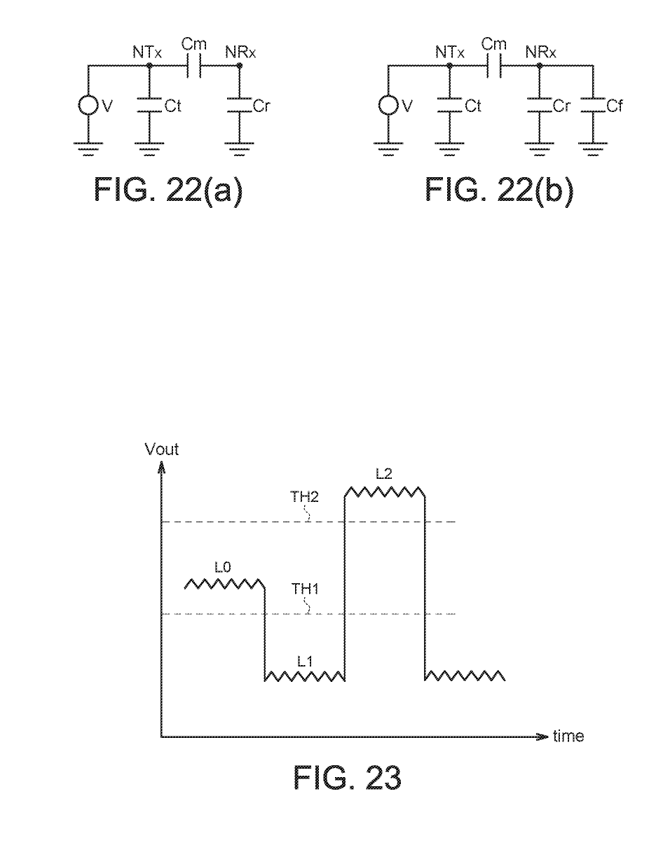

FIGS. 22(a)-22(b) are relevant equivalent circuit diagrams of the touch display device 1800/1900 of FIGS. 20 and 21 under different touch events. NTx and NRx respectively represent the node located on the transmitter electrode layer (corresponding to the second electrode layer EL2) and the node located on the receiver electrode layer (corresponding to the first electrode layer EL1). Suppose the voltage at the node NTx is V. The voltage V can be expressed as expressed as:

V=Vm+Vr (Formula 11)

Wherein Vm represents the cross-voltage crossing the two ends of the capacitor Cm; Vr represents the cross-voltage crossing the two ends of the capacitor Cr.

FIG. 22(a) is an equivalent circuit diagram of the touch display device 1800/1900 when no touch event occurs.

When no touch event occurs, the cross-voltage Vr crossing the two ends of the capacitor Cr can be expressed as:

$$Vr = \frac{Cm}{Cr + Cm} \times V \qquad ( Formula 12 )$$

The cross-voltage Vm crossing the two ends of the capacitor Cm can be expressed as:

$$Vm = \frac{Cr}{Cr + Cm} \times V \qquad ( Formula 13 )$$

Meanwhile, the sensing output signal Vout generated by the controller according to the signal of the node NRx can be expressed as:

$$Vout = Vr \times n = \frac{Cm}{Cr + Cm} \times V \qquad ( Formula 14 )$$

Wherein n represents the number of sensing cycles, and n is a positive integer.

Refer to FIG. 22(b), equivalent circuit diagram of the touch display device 1800/1900 when a touch event occurs. As indicated in FIG. 22(b), when a plane touch event occurs, a capacitor Cf will be formed at the node NRx due to the touch event. Meanwhile, the cross-voltage Vr crossing the two ends of the capacitor Cr can be expressed as:

$$Vr = \frac{Cm}{Cr + Cm + Cf} \times V \qquad ( Formula 15 )$$

The cross-voltage Vm crossing the two ends of the capacitor Cm can be expressed as:

$$Vm = \frac{Cr + Cf}{Cr + Cm + Cf} \times V \qquad ( Formula 16 )$$

The sensing output signal Vout generated by the controller according to the signal of the node NRx can be expressed as:

$$Vout = Vr \times n = \frac{Cm}{Cr + Cm + Cf} \times V \times n \qquad ( Formula 17 )$$

Wherein n represents the number of sensing cycles, and n is a positive integer.

In comparison to Formula 14, it can be known that the capacitor Cf generated due to the touch event will make the sensing output signal Vout become smaller. However, when the object OB heavily presses the touch display device, the capacitor Cm will become larger and make the value of the sensing output signal Vout increase significantly. The increase in signal value allows the controller to determine one or more than one touch state.

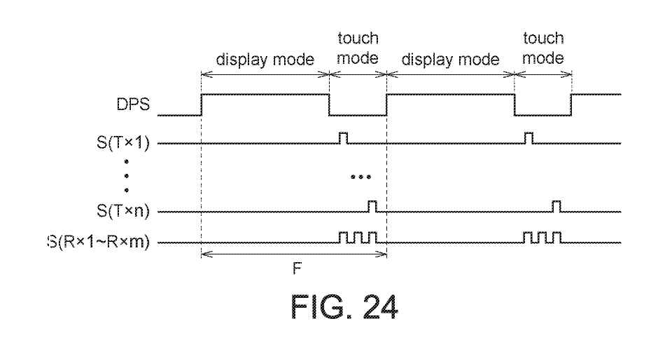

As indicated in FIG. 23, when no touch event occurs, the value of the sensing output signal Vout will become L0, which is between the first threshold TH1 and the second threshold TH2. When a simple plane touch event (not heavy pressing), the value of the sensing output signal Vout will become L1, which is lower than the first threshold TH1. When the pressing touch event occurs, the value of the sensing output signal Vout will be increased to L2, which is higher than the second threshold TH2. Therefore, the controller can determine whether a touch event occurs and differentiate the nature of the touch event according to the sensing output signal Vout and the relationship between the first and the second thresholds TH1 and TH2. FIG. 24 is an example of a schematic diagram of relevant signal operations for pixel transistors by a controller when the touch display device is operated under different modes. In the present example, the touch display device includes the first electrode layer EL1 and the second electrode layer EL2 of FIG. 19, wherein the first electrode layer EL1 includes a plurality of receiver electrodes Rx1-Rxm, and the second electrode layer EL2 includes a plurality of transmitter electrodes Tx1-Txn.

The touch display device is alternately operated between the display mode and the touch mode to achieve touch display function. As indicated in FIG. 24, the touch display device is sequentially operated under the display mode and the touch mode within a frame of operation time F. It should be noted that the timing sequence of FIG. 24 is merely used to make the disclosure easier to understand, not to limit the disclosure. In other embodiments, the touch display device can be selectively operated under the display mode or the touch mode according to the arrangement of timing sequence.

The signals transmitted on the transmitter electrodes Tx1-Txn are signals S(Tx1)-S(Txn). In the display mode, the signals S(Tx1)-S(Txn) are at a designated level, such as a common voltage level. In the touch mode, the signals S(Tx1)-S(Txn) are sequentially enabled.

The signals transmitted on the receiver electrodes Rx1-Rxm respectively are signals S(Rx1)-S(Rxm). In the display mode, the signals S(Rx1)-S(Rxm) are at a designated level, such as a common voltage level. In the touch mode, the signals S(Rx1-)-S(Rxm) will change in response to the signals S(Tx1-)-S(Txn). The controller can determine whether a touch event occurs and differentiate the nature of the touch event according to the magnitudes of the signals S(Rx1-)-S(Rxm).

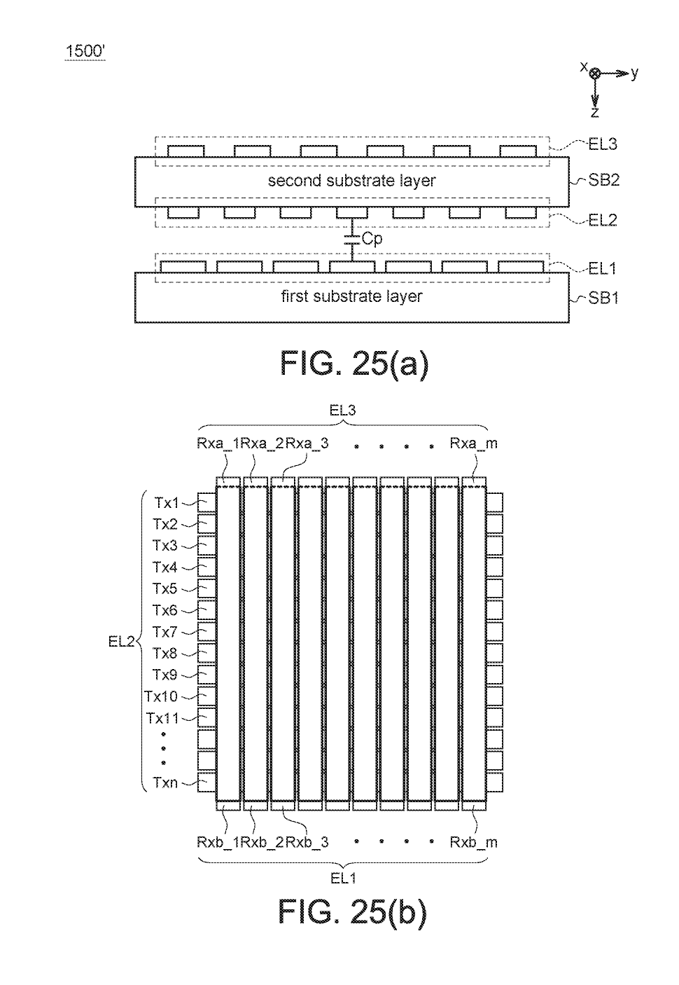

FIGS. 25(a), 25(b), 26, 27, 28(a), 28(b), 29, 30(a), 30(b), 31, and 32 refer to a fourth embodiment of the disclosure.

FIG. 25(a) is a cross-sectional view of a touch display device 1500′ according to an embodiment of the disclosure. In the present embodiment, the touch electrode layer EL3 is disposed on the side of the second substrate layer opposite to the second electrode layer EL2. The controller of the touch display device 1500′ can detect a plane touch event by sensing a change in the signal outputted from the touch electrode layer EL3, and detect a pressing touch event by sensing a change in the signal outputted from the first electrode layer EL1 (such as pressing along the z direction).

As shown in FIG. 25(a), the first electrode layer EL1 is used as a receiver electrode layer, the second electrode layer EL2 is used as a transmitter electrode layer, and the third electrode layer is used as a receiver electrode layer. The first electrode layer EL1 and the second electrode layer EL2 can be used for sensing a pressing touch event, and the second electrode layer EL2 and the third electrode layer EL3 can be used for sensing a plane touch event.

As indicated in the embodiment of FIG. 25(b), the first electrode layer EL1 and the second electrode layer EL2 respectively are used as a receiver electrode layer and a transmitter electrode layer for sensing a pressing touch event, and the third electrode layer EL3 is used as a receiver electrode layer. The third electrode layer EL3 and the second electrode layer EL2 can be used for sensing a plane touch event.

In the present example, the first electrode layer EL1 is patterned as a plurality of receiver electrodes Rxb_1-Rxb_m electrically isolated from each other; the second electrode layer EL2 is patterned as a plurality of transmitter electrodes Tx1-Txn electrically isolated from each other; the third electrode layer EL3 is patterned as a plurality of receiver electrodes Rxa_1-Rxa_m electrically isolated from each other, wherein m, n are positive integers. The receiver electrodes Rxa_1-Rxa_m, Rxb_1-Rxb_m are arranged in multiple columns, and the transmitter electrodes Tx1-Txn are arranged in multiple rows. For example, the receiver electrodes Rxa_1-Rxa_m, Rxb_1-Rxb_m are parallel with the data lines of the pixel matrix and overlap with the light shielding layer; the transmitter electrodes Tx1-Txn are parallel with the gate lines of the pixel matrix and overlap with the light shielding layer.

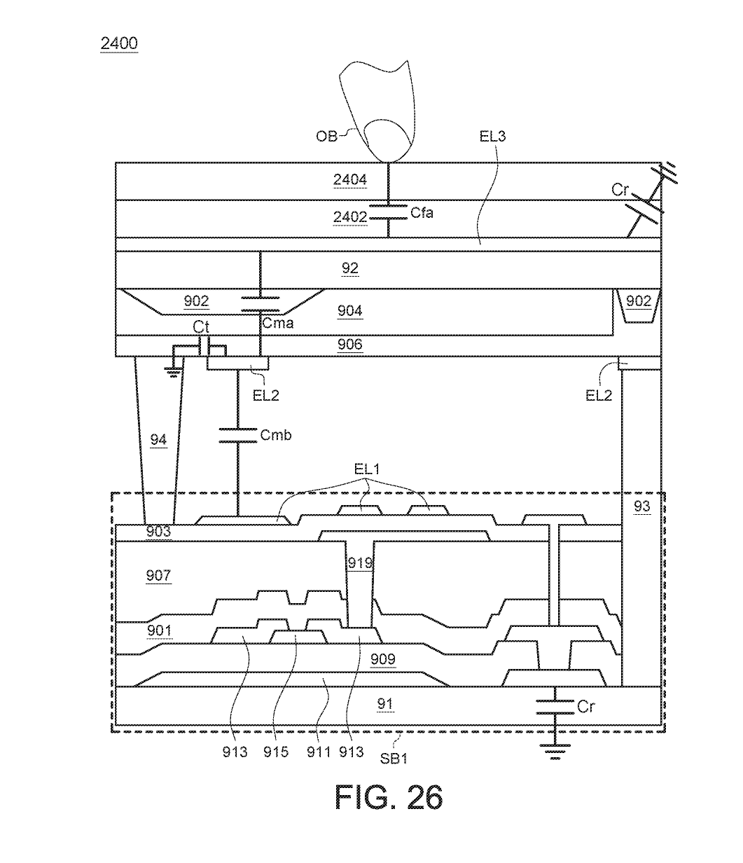

FIG. 26 is an example of a cross-sectional view of a touch display device 2400 when a touch event occurs according to an embodiment of the disclosure. The touch display device 2400 is similar to the touch display device 900 adopting a top common structure. For the convenience of explanation, elements of the touch display device 2400 similar to or identical to that of above embodiments retain the same designations.

The substrate 92 of the touch display device 2400 has a third electrode layer EL3 disposed thereon. The third electrode layer EL3 has a dielectric layer 2402 (such as an optically clear adhesive/resin layer or an air layer) disposed thereon. The dielectric layer 2402 has a cover glass 2404 disposed thereon. In the present example, the first electrode layer EL1 and the second electrode layer EL2 respectively are used as a receiver electrode layer and the transmitter electrode layer for sensing a pressing touch event. The third electrode layer EL3 is used as a receiver electrode layer. The third electrode layer EL3 and the second electrode layer EL2 can be used for sensing a plane touch event.

The second electrode layer EL2 forms a capacitor Ct with respect to the ground. The first electrode layer EL1 forms a capacitor Cr with respect to the ground. A capacitor Cma is formed between the third electrode layer EL3 and the second electrode layer EL2. A capacitor Cmb is formed between the first electrode layer EL1 and the second electrode layer EL2. When the object OB touches the touch display device 2400, a capacitor Cfa will be generated between the object OB and the third electrode layer EL3 of the touch display device 2400.

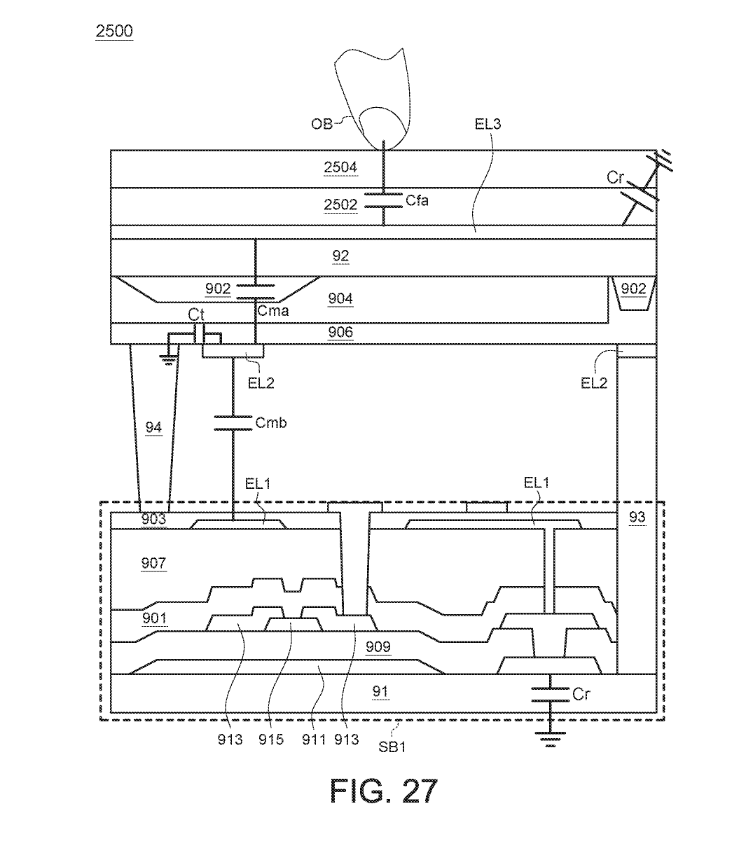

FIG. 27 is an example of a cross-sectional view of a touch display device 2500 when a touch event occurs according to an embodiment of the disclosure. The touch display device 2500 is similar to the touch display device 1200 adopting a top pixel structure. For the convenience of explanation, elements of the touch display device 2500 similar to or identical to that of above embodiments retain the same designations.

The substrate 92 of the touch display device 2500 has a third electrode layer EL3 disposed thereon. The third electrode layer EL3 has a dielectric layer 2502 (such as an optically clear adhesive/resin layer or an air layer) disposed thereon. The dielectric layer 2502 has a cover glass 2504 disposed thereon. In the present example, the first electrode layer EL1 and the second electrode layer EL2 respectively are used as a receiver electrode layer and a transmitter electrode layer for sensing a pressing touch event. The third electrode layer EL3 is used as a receiver electrode layer. The third electrode layer EL3 and the second electrode layer EL2 can be used for sensing a plane touch event. The second electrode layer EL2 forms a capacitor Ct with respect to the ground. The first electrode layer EL1 forms a capacitor Cr with respect to the ground. A capacitor Cm is formed between the first electrode layer EL1 and the second electrode layer EL2b. When the object OB touches the touch display device 2500, a capacitor Cfa will be generated between the object OB and the third electrode layer EL3 of the touch display device 2500.

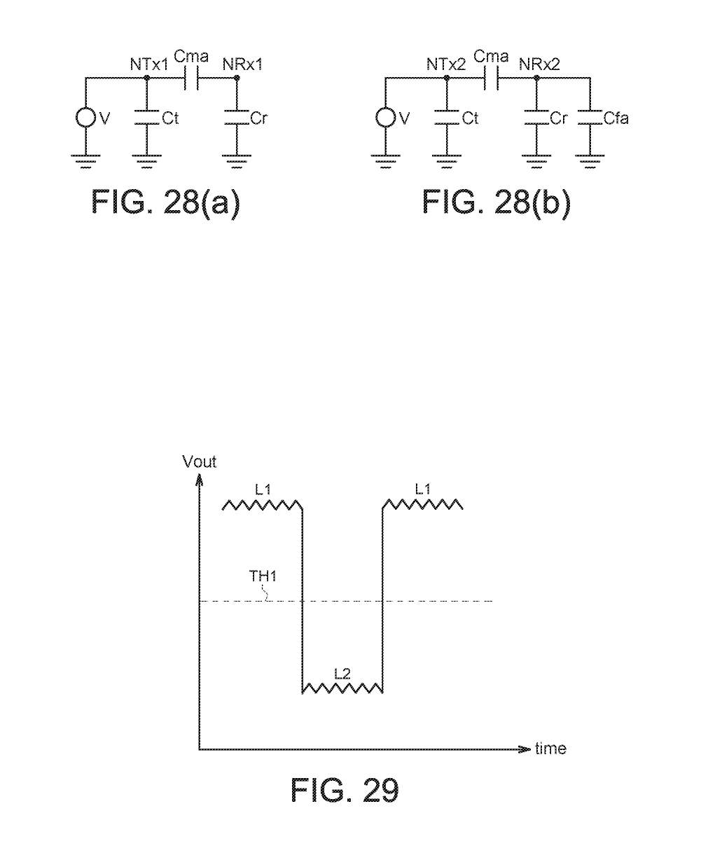

FIGS. 28(a)-28(b) are relevant equivalent circuit diagrams of the touch display device 2400/2500 of FIGS. 26 and 27 when a plane touch event occurs. NTx1 and NRx1 respectively represent the node located on the transmitter electrode layer (corresponding to the second electrode layer EL2) and the node located on the receiver electrode layer (corresponding to the third electrode layer EL3). Suppose the voltage at the node NTx1 is V. The voltage V can be expressed as:

V=Vm+Vr (Formula 18)

Wherein Vm represents a cross-voltage crossing the two ends of the capacitor Cma; Vr represents a cross-voltage crossing the two ends of the capacitor Cr.

FIG. 28(a) is an equivalent circuit diagram of the touch display device 2400/2500 for sensing a plane touch event when no touch event occurs.

When no touch event occurs, the cross-voltage Vr crossing the two ends of the capacitor Cr can be expressed as:

$$Vr = \frac{Cma}{Cr + Cma} \times V \qquad ( Formula 19 )$$

The cross-voltage Vm crossing the two ends of the capacitor Cma can be expressed as:

$$Vm = \frac{Cr}{Cr + Cma} \times V \qquad ( Formula 20 )$$

Meanwhile, the sensing output signal Vout generated by the controller according to the signal of the node NRx1 can be expressed as:

$$Vout = Vr \times n = \frac{Cma}{Cr + Cma} \times V \qquad ( Formula 21 )$$

Wherein n represents the number of sensing cycles, and n is a positive integer.

Refer to FIG. 28(b). FIG. 28(b) is a relevant equivalent circuit diagram of the touch display device 2400/2500 of FIGS. 26 and 27 when a plane touch event occurs. As indicated in FIG. 28(b), when a plane touch event occurs, a capacitor Cfa will be formed at the node NRx1 due to the touch event. Meanwhile, the voltage Vr can be expressed as:

$$Vr = \frac{Cma}{Cr + Cma + Cfa} \times V \qquad ( Formula 22 )$$

The cross-voltage Vm crossing the two ends of the capacitor Cm can be expressed as:

$$Vm = \frac{Cr + Cfa}{Cr + Cma + Cfa} \times V \qquad ( Formula 23 )$$

The sensing output signal Vout generated by the controller according to the signal of the node NRx1 can be expressed as:

$$Vout = Vr \times n = \frac{Cma}{Cr + Cma + Cfa} \times V \times n \qquad ( Formula 24 )$$

Wherein n represents the number of sensing cycles, and n is a positive integer.

In comparison to Formula 21, it can be known that the capacitance of the capacitor Cfa generated due to the plane touch event will make the sensing output signal Vout become smaller. As indicated in FIG. 29, when no touch event occurs, the corresponding sensing output signal Vout will be at level L1, which is higher than the first threshold TH1. When a plane touch event occurs, the corresponding sensing output signal Vout will be at level L2, which is lower than the first threshold TH1.

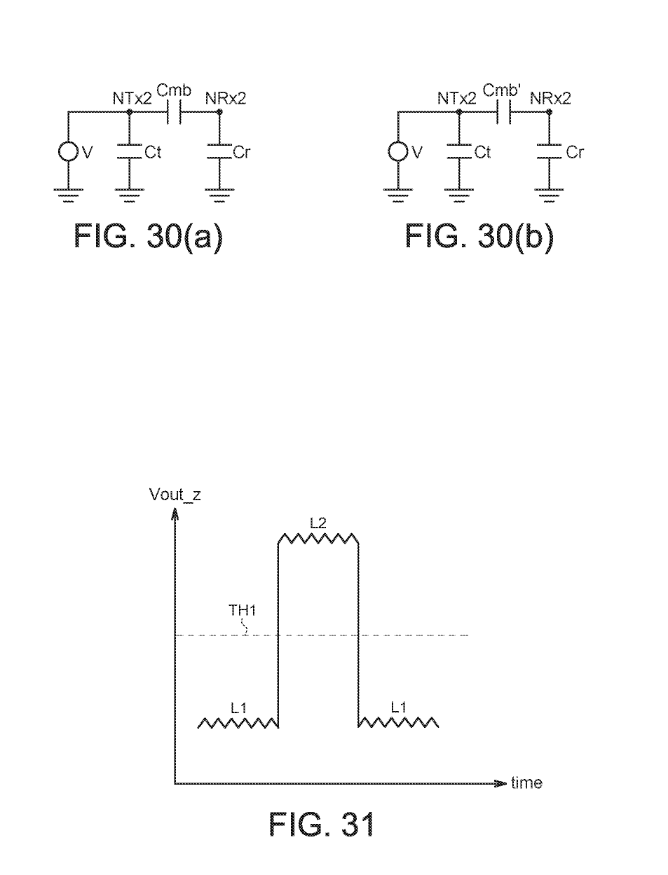

FIGS. 30(a)-30(b) are relevant equivalent circuit diagrams of the touch display device 2400/2500 of FIGS. 26 and 27 when a pressing touch event occurs. NTx2 and NRx2 respectively represent the node located on the transmitter electrode layer (corresponding to the second electrode layer EL2) and the node located on the receiver electrode layer (corresponding to the first electrode layer EL1). Suppose the voltage at the node NTx2 is V. The voltage V can be expressed as:

V=Vm+Vr (Formula 25)

Wherein Vm represents a cross-voltage crossing the two ends of the capacitor Cmb; Vr represents a cross-voltage crossing the two ends of the capacitor Cr.

FIG. 30(a) is an equivalent circuit diagram of the touch display device 2400/2500 for sensing the pressing touch event when no touch event occurs.

When no pressing touch event occurs, the cross-voltage Vr crossing the two ends of the capacitor Cr can be expressed as:

$$Vr = \frac{Cmb}{Cr + Cmb} \times V \qquad ( Formula 26 )$$

The cross-voltage Vm crossing the two ends of the capacitor Cmb can be expressed as:

$$Vm = \frac{Cr}{Cr + Cmb} \times V \qquad ( Formula 27 )$$

Meanwhile, the sensing output signal Vout generated by the controller according to the signal of the node NRx2 can be expressed as:

$$Vout = Vr \times n = \frac{Cmb}{Cr + Cmb} \times V \qquad ( Formula 28 )$$

Wherein n represents the number of sensing cycles, and n is a positive integer.

FIG. 30(b) is an equivalent circuit diagram of the touch display device 2400/2500 when a pressing touch event occurs. As indicated in FIG. 30(b), when a pressing touch event occurs, the capacitance of the capacitor Cmb will increase to Cmb′, so the voltage Vr can be expressed as:

$$Vr = \frac{{Cmb}^{′}}{Cr + {Cmb}^{′}} \times V \qquad ( Formula 29 )$$

The cross-voltage Vm crossing the two ends of the capacitor Cm can be expressed as:

$$Vm = \frac{Cr}{Cr + {Cmb}^{′}} \times V \qquad ( Formula 30 )$$

The sensing output signal Vout generated by the controller according to the signal of the node NRx2 can be expressed as:

$$Vout = Vr \times n = \frac{Cmb}{Cr + Cmb} \times V \times n \qquad ( Formula 31 )$$

Wherein n represents the number of sensing cycles, and n is a positive integer.

In comparison to Formula 28, the sensing output signal Vout will become larger due to the pressing touch event. As indicated in FIG. 31, when no touch event occurs, the corresponding sensing output signal Vout will be at level L1, which is lower than the first threshold TH1. When the pressing touch event occurs, the corresponding sensing output signal Vout will be at level L2, which is higher than the first threshold TH1.

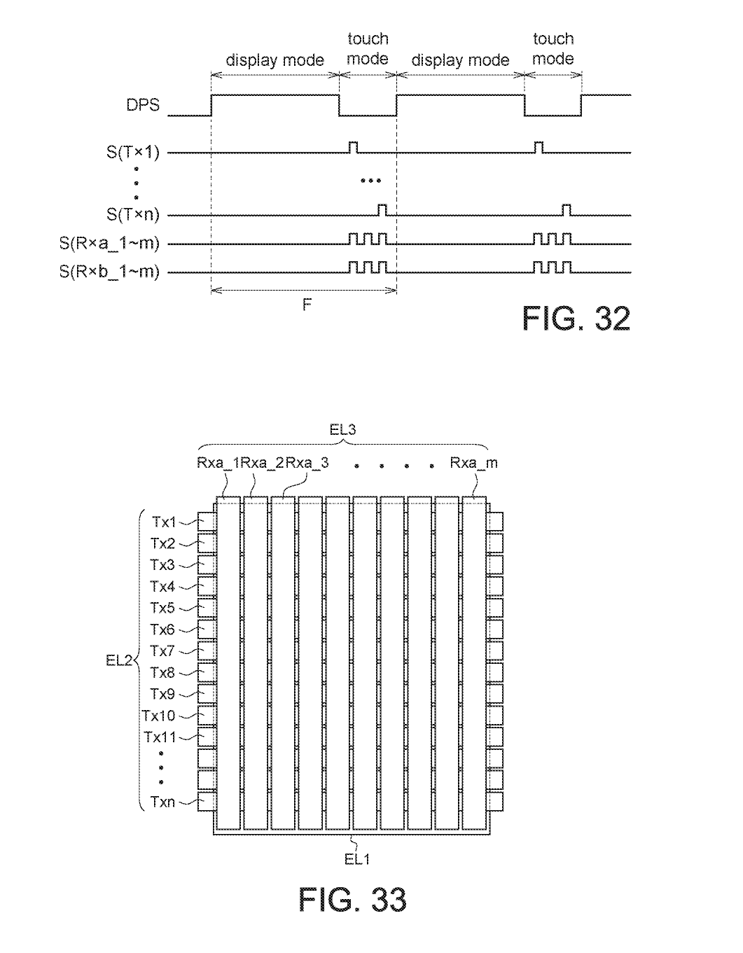

FIG. 32 is an example of a schematic diagram of relevant signal operations for transistors by a controller when the touch display device is operated under different modes. In the present example, the touch display device includes the first electrode layer EL1, the second electrode layer EL2 and the third electrode layer EL3 of FIG. 24, wherein the first electrode layer EL1 includes a plurality of receiver electrodes Rxb_1-Rxb_m; the second electrode layer EL2 includes a plurality of transmitter electrodes Tx1-Txn; the third electrode layer EL3 includes a plurality of receiver electrodes Rxa_1-Rxa_m.

The touch display device is alternately operated between the display mode and the touch mode to achieve touch display function. As indicated in FIG. 32, the touch display device is sequentially operated under the display mode and the touch mode within a frame of operation time F. It should be noted that the timing sequence of FIG. 32 is merely used to make the disclosure easier to understand, not to limit the disclosure. In other embodiments, the touch display device can be selectively operated under the display mode or the touch mode according to the arrangement of timing sequence.

The signals transmitted on the transmitter electrodes Tx1-Txn respectively are signals S(Tx1)-S(Txn). In the display mode, the signals S(Tx1)-S(Txn) are at a designated level, such as a common voltage level. In the touch mode, the signals S(Tx1)-S(Txn) are sequentially enabled.

The signals transmitted on the receiver electrodes Rxa_1-Rxa_m respectively are signals S(Rxa_1)-S(Rxa_m). In the display mode, the signals S(Rxa_1)-S(Rxa_m) are at a designated level, such as a common voltage level. In the touch mode, the signals S(Rxa_1)-S(Rxa_m) will change in response to the signals S(Tx1)-S(Txn). The controller can determine whether a plane touch event occurs according to the magnitudes of the signals S(Rxa_1)-S(Rxa_m).

Likewise, the signals transmitted on the receiver electrodes Rxb_1-Rxb_m respectively are signals S(Rxb_1)-S(Rxb_m). In the display mode, the signals S(Rxb_1)-S(Rxb_m) are at a designated level, such as a common voltage level. In the touch mode, the signals S(Rxb_1)-S(Rxb_m) will change in response to signals S(Tx1)-S(Txn). The controller can determines whether the pressing touch event occurs according to the magnitudes of the signals S(Rxb_1)-S(Rxb_m).

FIG. 33 is an example of a top view of a first electrode layer EL1, a second electrode layer EL2 and a third electrode layer EL3. In the example illustrated in FIG. 33, the first electrode layer EL1 and the second electrode layer EL2 respectively are used as a receiver electrode layer and a transmitter electrode layer for sensing a pressing touch event. The third electrode layer EL3 is used as a receiver electrode layer. The third electrode layer EL3 and the second electrode layer EL2 can be used for sensing a plane touch event. The embodiment of FIG. 33 is different from the embodiment of FIG. 25(b) mainly in that: the first electrode layer EL1 is a complete plane, and is not patterned as strips.

According to the touch display device of the disclosure, an electrode layer is disposed on an inner side of the second substrate layer (such as a color filter substrate or a transparent substrate) of the touch panel. A capacitor is formed by the electrodes on the second substrate layer and the electrodes on the first substrate layer (such as pixel thin-film transistor substrate), such that the sensing output signal generated after the touch display device is pressed can increase significantly. Thus, the controller can determine whether the touch event is a plane touch event or a pressing touch event according to the magnitude of the sensing output signal. Such architecture not only provides pressure sensing function without installing any pressure sensors but also increases relevant signal quality and improves overall touch and display function.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch display device, comprising:
a first substrate layer, comprising a plurality of transistors;
a second substrate layer, disposed opposite to the first substrate layer;
a first electrode layer, disposed over the first substrate layer and interposed between the first substrate layer and the second substrate layer;
a second electrode layer, disposed over the second substrate layer and interposed between the first substrate layer and the second substrate layer; and
a controller electrically connected to the first electrode layer, wherein the controller outputs a first signal to the first electrode layer when the touch display device is operated under a display mode and outputs a second signal to the first electrode layer when the touch display device is operated under a touch mode;
wherein when the touch display device is operated under the touch mode, the controller generates a sensing output signal and determines that a touch event occurs when the value of the sensing output signal is greater than a first threshold, the controller further determines that a pressing touch event occurs when the value of the sensing output signal is greater than a second threshold.

2. The touch display device according to claim 1, wherein the second threshold is higher than the first threshold.

3. The touch display device according to claim 1, wherein the controller further determines a pressure state corresponding to the pressing touch event according to a third threshold.

4. The touch display device according to claim 1, wherein the second substrate layer comprises a black matrix, the second electrode layer is interposed between the black matrix and the first electrode layer and located within an optical shielding area covered by the black matrix.

5. The touch display device according to claim 1, wherein the first substrate layer comprises a plurality of data lines and a plurality of scan lines crossing the data lines, and the transistors are electrically connected to the data lines and the scan lines;
wherein an electrode pattern of the second electrode layer overlaps or parallels the data lines.

6. The touch display device according to claim 1, wherein the first substrate layer comprises a plurality of data lines and a plurality of scan lines crossing the data lines, and the transistors are electrically connected to the data lines and the scan lines;
wherein an electrode pattern of the second electrode layer overlaps or parallels the scan lines.

7. The touch display device according to claim 1, wherein the first substrate layer comprises a plurality of data lines and a plurality of scan lines crossing the data lines, and the transistors are electrically connected to the data lines and the scan lines respectively;
wherein an electrode pattern of the second electrode layer overlaps or parallels the data lines and the scan lines.

8. The touch display device according to claim 1, further comprising:
a connection element located within a non-display area of the touch display device, and the second electrode layer electrically connected to the first substrate layer through the connection element.

9. The touch display device according to claim 1, wherein a voltage of the second electrode layer is a common voltage or a ground voltage, or the second electrode layer is in a floating state.

10. The touch display device according to claim 1, wherein the first electrode layer comprises a plurality of unit electrode blocks electrically isolated from each other, and each of the unit electrode blocks is connected to the controller through a metal wire.

11. The touch display device according to claim 10, wherein each of the unit electrode blocks is electrically connected to a plurality of dummy metal wires, and the dummy metal wires are electrically isolated from the controller.

12. The touch display device according to claim 1, wherein the first electrode layer comprises a plurality of transmitter electrodes and a plurality of receiver electrodes, and the transmitter electrodes intersect with the receiver electrodes and are connected to the controller.

13. The touch display device according to claim 1, further comprising:
a touch electrode layer disposed over a side of the second substrate layer opposite to the second electrode layer;
wherein the controller detects the plane touch event according to a touch sensing output signal outputted from the touch electrode layer.

14. The touch display device according to claim 13, wherein the touch electrode layer is used as a self-capacitive touch structure.

15. The touch display device according to claim 1, wherein the first substrate layer comprises a pixel electrode electrically connected to one of the transistors.

16. The touch display device according to claim 1, wherein the first substrate layer comprises a pixel electrode disposed between the first electrode layer and the second electrode layer and is electrically connected to one of the transistors.

17. The touch display device according to claim 1, wherein the second substrate layer comprises a color filter.

18. The touch display device according to claim 1, wherein a part of the first electrode layer is used as a transmitter electrode layer and another part of the first electrode layer is used as a receiver electrode layer.

19. The touch display device according to claim 1, wherein the first electrode layer is used as a transmitter electrode layer, and the second electrode layer is used as a receiver electrode layer.

20. The touch display device according to claim 1, wherein the first electrode layer is used as a receiver electrode layer, and the second electrode layer is used as a transmitter electrode layer.
